(19) United States
(12) Patent Application Publication
(10) Pub. No.: US 2007/0157424 A1
(43) Pub. Date: Jul. 12, 2007

(54) Bag carrying device for a vacuum/blower

(76) Inventor: Soheyl Mottahedeh, Vacouver (CA)

Correspondence Address: LADAS & PARRY LLP, 224 SOUTH MICHIGAN AVENUE, SUITE 1600, CHICAGO, IL, 60604, US

(21) Appl. No.: 10/585,227

(22) PCT Filed: Dec. 29, 2004
(86) PCT No.: PCT/CA04/02204

§ 371 Date: Nov. 6, 2006

(30) Foreign Application Priority Data
Dec. 31, 2003 (CA) 2,452,291

(51) Int. Cl. B65D 33/10; B65D 33/01; B02C 23/00; F01D 25/00; A45F 3/14; A47L 9/00

(52) U.S. Cl. 15/405; 15/330; 241/55; 415/121.1; 383/103; 383/9; 224/257

(57) ABSTRACT

The present invention provides a bag carrying device for a vacuum/blower device (20). The bag carrying device comprises: a bag body (10) with a bag opening (50) and a bag carrying arrangement (65) for removable engagement with a discharge portion (24) of the vacuum/blower device (20); and a bag carrying assembly with a support member (40), carrying member (80) and a securing member (120) for a shoulder carrying of the bag carrying device during collecting debris. The bag carrying arrangement (65) is to receive the bag carrying assembly. The opening (50) is to receive a discharge portion (24) of the vacuum/blower device (20). The securing member (120) is to secure the bag opening (50) around the discharge portion (24) of the vacuum/blower device (20).

### FIELD OF THE INVENTION

The present invention relates generally to power blower/vacuum equipment and more specifically it relates to a carry-ready disposable perforated bag.

### BACKGROUND OF THE INVENTION

Various accessories have been provided in prior art that are adapted to be used in conjunction with various types of power blower/vacuums, so that users can either blow leaves to pile them or vacuum them into small fabric shoulder bags. The shoulder bags associated with hand-held blower/vacuum equipment are made of non-disposable fabric requiring that they be emptied into disposable bags—a frustrating and time consuming activity. In addition, these bags are small in capacity and require frequent emptying. Larger size leaf collection systems adaptable to fit over large garbage containers have been tried and been discontinued. They make bagging of leaves a cumbersome activity. When the bags are full, trying to extract a disposal bag compacted with leaves from a tall garbage can is difficult and requires strength. If bags are not completely filled with leaves, it may be easier to lift them out of the cans, but then holding capacity is severely reduced. Other forms of bagging by hand are considered to be a burdensome chore. Bagging by hand is often assisted by various forms of stationary bag holders to keep bags open during fill up. While these units may be suitable for the particular purpose for which they were created, leaf collection remains a cumbersome multi-step process.

Another aspect to consider in the disposal of leaves is their environmental impact which can be reduced if bags for disposal of organic elements employ biodegradable materials such as biodegradable and compostable plastics and recycled paper.

While a number of solutions have been proposed for improving collection and bagging of leaf and lawn debris using lawn mowers as lawn vacuums, little progress has been achieved in improving disposable plastic and paper bag designs to increase the efficiency of the bagging process using power blower/vacuum equipment. The present invention is both effective and efficient allowing for the easy collection of leaves into disposable bags designed for ease of handling and quick disposal.

Blower/vacuum devices of the type mentioned above are made, for example, by Black & Decker Co. called “Gas Blower/Vac” and “Vac 'N' Mulch”. A device of this type is also shown, for example, in U.S. Pat. No. 4,325,163 which is assigned to Allegretti & Company. The Allegretti makes also a blower/vacuum device called “Vac-N-Sac”. Typically, these devices offer as accessory attachments a small leaf collection bag.

Kline et al in U.S. Pat. No. 4,747,259 disclose a grass catching discharge pipe employing a closed plastic disposable bag which is missing adequate design for air removal and evenness of bag fill.

Donegan in U.S. Pat. No. 4,470,246 discloses an automatic complex-mechanical lawn clippings bagger that positions stored disposable bags and then moves to an operating location over the discharge chute of the power mower; this unit is missing adequate design for air removal and evenness of bag fill.

Leaphart in U.S. Pat. No. 4,397,063 discloses a safety bag housing containing a sparsely perforated disposable bag; this unit is missing adequate design for air removal in order to assure evenness and completeness of bag fill. The perforated bag requires a base pan for support. The bag mouth is fully open. The bag is adapted to be connected to a power vacuum.

Machado et al in U.S. Pat. No. 4,686,546 disclose a perforated disposable bag holder for the rear of a power lawn vacuum using a long duct to fill the vertically positioned bag. The bag made of a polyethylene plastic with small air holes to vent the bag has a wide opening for entry of grass clippings and rests over a platform of a power vacuum. The bag does not have seams to make it carryable and no opening for attachment to a blower/vacuum.

Krewson in U.S. Pat. No. 3,574,210 discloses a lawn and leaves rake power vacuum where the bag is a fabric bag containing an inner perforated disposable plastic bag. The bag one end has a wide opening for entry of grass clippings coming from a power vacuum and the bag other end is attached to a support.

Voigt in U.S. Pat. No. 5,673,544 discloses a disposable lawn mower debris bag system where from a roll of perforated bags a single bag is attached to the discharge chute of a power lawn mower. The bags are perforated but need support and are of traditional configuration, have no opening arrangements, no drainage exits and no provision is made for their subsequent handling after fill up. The apparatus is not designed to be an accessory to a power blower/vacuum but rather to a lawn mower.

Kelber in U.S. Pat. No. 4,713,858 discloses a leaf collection apparatus for use with a blower/vacuum device which collects and discharges the collected leaves through a flexible tube into a large container. To vent air, a shroud or skirt is adapted to fit over the top of the container. While leaf collection is easily achieved by the device, is quick and without the typical problems of sagging sides and misdirected leaves when plastic bags are used, the device is cumbersome to handle. It requires strength to pull out a loaded disposable bag from tall garbage-type containers that associate with the bag, a condition further exacerbated if bags were to be compacted even further. The apparatus uses traditional disposable bags that need to be encased and supported in a container, the bags are not perforated, have no special opening or drainage exit portals and their handling are difficult during extraction from tall containers.

All prior devices have significant shortcomings. For example, many of these devices require the direct manual transfer of debris into a receptacle, therefore are inefficient and time-consuming. Some devices do not permit the efficient transfer of debris into a receptacle by use of air pressure, some have complex designs, are mechanically ineffective, cumbersome to use, demand tedious handling during the final bagging stage and are not cost effective. Most address problems associated with lawn mowers and the few addressing problems with power blower/vacuums are cumbersome to use.

### OBJECTS OF THE INVENTION

An object of the present invention is to provide an improved bag for a fluid displacement device.

It is a purpose of this invention to overcome deficiencies noted in the aforementioned prior art. This includes providing an apparatus that makes a collection bag for a fluid-displacement device such as a blower/vacuum, whether engine or electrically operated, more user-friendly by increasing their capacity, making bags easier to carry, faster to replace, and disposal of bags and of their content more convenient.

A purpose of the invention is to provide an improved bag handling system wherein the combined arrangement of various seams incorporated into the bag create a bag-carrying arrangement that makes the bag easily carryable and convenient to handle. With the bag-carrying assembly of the invention such as an insertable handle, a user can shoulder-carry, lift the bag at any time or rest it or drag it on the ground, while vacuuming any elements such as lawn and garden debris, agricultural grains or environmental residues, thus avoiding the need to carry the bag's weight unnecessarily.

Another purpose of the invention is to provide a fast, easy and cost-effective bag-carrying assembly that, in a single-step, allows to collects leaves, to bag them directly into a perforated bag ready to be carried and disposed of without the need to tie or transfer them into another disposable bag thus avoiding the double material transfer of the prior art.

Another object of the invention is to provide a disposable bag made of plastic, paper having holes or of porous materials including woven fibers, which maximize the bag's capacity for containing leaves, as contents in the bags of the invention fill the bags from their bottom seam to their upper seam. Furthermore, fluid-displacement devices usually mulch 10:1 thus provide users with the ability to pack more content in the same bag volume than when filled by hand.

Another object of the invention is to provide an environmentally responsible bag that collects leaves in a biodegradable plastic or paper bag that is adequately vented to promote faster composting.

Another purpose of the invention is to improve the design of consumer garbage bags wherein said improvement results directly into a reduction of the cumbersome and time-consuming bagging chore. Ease of handling is further accomplished by providing various bag sizes to accommodate the bagging activity by persons of various sizes.

Another purpose of the invention is to provide a safe mechanized bagging system wherein any solid item picked up by the vacuum and ejected via the chute is safely projected downwards, toward the ground.

Another object of the invention is to provide an accessory to existing power blower/vacuum equipment by providing a collection, bagging and bag-carrying assembly that is simple in design, quickly mountable, economical in cost to manufacture and requires very little storage space.

A further purpose of the invention is to provide a collection, bagging and a bag-carrying assembly that is customizable to different types of vacuumable elements, dry or wet, by matching the nature of the elements, the size, shape and air venting requirements of the collection bag and the amount of air produced by the specific power vacuum employed. Besides leaves, other vacuumable elements such as seeds, grains, small fruits, debris, wood chips, wet and dry food-processing residues, wet residues, objects and residues from assembly lines or from factories, environmental residues, and elements of the like can be vacuumed and discharged into a perforated plastic bag, for either storage or disposal purposes. With a bag made from cellulose or other edible material, edible contents including the bag, can be consumed in whole by any of a variety of grazing animals.

Another purpose of the invention is to provide a bag-carrying assembly that comprises a collection bag that cooperates with a dust cover to deflect dust away from the user.

Still another purpose of the invention is to collect environmental, agricultural or commercial elements in a vented bag that uses a cover that, after being used to deflect air or dust, is used to package and seal the bag content.

Another purpose of the invention is to collect and bag rapidly leaves and other compostable materials in substantially closed, large size, perforated, paper lawn refuse bags using a support member such as a clamp-type handle and a shoulder strap arrangement of the invention. Furthermore, loaded paper bags can be easily and autonomously handled and lifted with the load-distributing handle and the shoulder strap arrangement of the invention.

Yet another purpose of the invention is to use a connector having a bifurcated conduit to convert a fluid-blowing device into a fluid-vacuuming device to displace fluid and entrain elements in the fluid into a bag of the invention.

A final purpose of the invention is to provide a bag-carrying assembly that uses support members such as handles that provides a bag support system that fit most fluid displacement devices.

Further objects of the invention will appear as the description proceeds.

### SUMMARY OF THE INVENTION

The present invention comprises a bag-carrying assembly for a fluid displacement device such as a blower/vacuum, a lawn mower or a pneumatic system which displaces a fluid such as air, vapour, water, wet residues or a gas to entrain elements into a vented disposable bag for collection of residues, grains, fruits or any elements from garden, agricultural, environmental or commercial sources. The bag-carrying assembly comprises a support member such as a handle to support and carry the bag and to secure it to the fluid-displacement device.

More specifically, the bag-carrying assembly comprises a vented bag best made of plastic, paper, linen, jute or any other fibrous material, where the bag includes a bag-carrying arrangement in the form of an inlet located at the bag top portion; the inlet is defined between two adjacent seams, an upper seam and a lower seam, some seams having a downward, a straight or an upward slanted arrangement depending on embodiments. Adjacent to the inlet which is configured to receive a support member, is a bag opening configured to receive a discharge portion of a fluid-displacement device or a connector that is in fluid communication with the discharge portion of a fluid-displacement device.

In an embodiment of the invention, the support member is configured as a hollow elongate member like a pipe that comprises a securing member such as a retractable band having a portion enclosed in the elongate member and a portion outside the elongate member forming outwardly a loop. When the loop is biased by a tension spring located in the hollow cavity of the support member, the loop secures the bag opening to the discharge portion of the fluid-displacement device. The bag-securing member is also provided with a stopper comprising a protrusion adapted to abut a shoulder positioned on the support member so as to position the securing member against the spring. By releasing the stopper, the loop retracts, tightening the bag opening around the discharge portion of the fluid-displacement device. In this embodiment, the bag-carrying member is comprised of a shoulder strap with a hook or a clip that carries the support member positioned inside the bag and that attaches to a corresponding aperture located on the elongate support member.

In another embodiment, the support member is configured in the shape of an alligator-type clamp that secures outwardly the bag along the upper seam(s) and around the discharge portion of the fluid-displacement device or that of a connector having rectangular, oval, round or a flexible hose configuration.

In an alternate embodiment, the securing member is comprised of a collar affixed at one end of an elongate support member such as a long handle configured to receive a bag-carrying member such as a strap to carry it.

In yet another embodiment of the invention, a bag-carrying assembly comprising a support member is configured like a wide jaw alligator-type clamp comprising a body comprising a middle portion flanked by opposite panels respectively defining end portions, said middle portion being mountable about at least a portion of said securing member; a pair of arms, each pivotally mounted at one end to a the end portion of a respective panel and comprising at an opposite end a lockable portion. The arms are hingeably mounted to the respective end portions. The clamp body defines a first half-jaw, the pair of arms defining a second complementary and cooperating half-jaw. The clamp middle portion comprises a semi-circle and the lockable portions define a complementary semi-circle when mated. The clamp lockable portions comprise a quarter-circle-shape collar. In use, after a pipe-like connector is inserted in the bag opening, the clamp surrounding the bag opening is closed, thus supporting both the bag opening and the side-seams forming the bag-carrying arrangement.

In another embodiment, the fluid displacement assembly of the invention comprises:

a bag comprising an inlet, said inlet comprising a bifurcation defining first and second sub inlet;

a fluid displacement device comprising a fluid-blowing portion mountable to said second sub-inlet;

when the fluid-blowing portion is inserted within said second sub-inlet receiving end and blows fluid therein a vacuum is created within the bag providing the first sub-inlet to displace fluid and any elements within the fluid therethrough into the bag.

In another embodiment of the invention, a fluid displacement assembly comprises a bag comprising an inlet,

a connector configured as a conduit mountable to said bag inlet comprising a conduit-inlet; the conduit-inlet comprising a bifurcation defining first and second sub inlet; a fluid displacement device comprising a fluid-blowing portion mountable to the second sub-inlet; wherein when the fluid-blowing portion is mounted to the second sub-inlet receiving end and blows air therein a vacuum is created within the first sub-inlet providing the connector to displace fluid and any elements within said fluid therethrough into said bag.

In yet another embodiment of the invention, a blowing fluid displacement device is provided with a bifurcated conduit-type connector for converting a blower-type device into a vaccuming-type device to entrain fluid and elements within said fluid into a vented bag of the invention.

Definitions

Band refers to an open, elongate, fastenable, generally narrow element such as, but not limited to, a strip, a stripe, a belt, a stretch, a strap, a ring, a tie, a leash, a bandage, a chain, a cinch, a lace, a rope, a tether, a wrap, a spring, a resilient cord, a wrappable resilient strap, and a combination thereof.

Collar refers to a generally closed or rapidly closable element such as, a loop, a buckle, a hoop, a clamp, a handcuff, a hook, a rubber band, a split ring pipe clamp, a quick release latch clamp, an over-center latch clamp, a spring loaded band clamp, a band having hooks and loops such as a VELCRO band and a combination thereof.

Connector refers to a hollow shape conduit, duct, pipe, adapter, a coupling, a joint, a junction, a fixture, a union, an attachment, a flexible hose,

Clip refers to a fastener, clasp, pin, staple, slide, tack, clutch, a grip, catch, clasp, clench, grip, hold, lock, nipper, press, snap, vice

Seam refers to intersection seams and seals such as, but not limited to, bond by fusion, glue, staple, line of stitching, joint, vein, rim, junction, standard sewn seams, “tape over sewn” seals, hot-melt tape over the sewing, wax-dipped seams, wax-dipped tape ends, and combinations thereof. Bag 10 is generally constructed with seals and seams produced by a process selected from the group such as local melting with a hot surface, heat sealing, sewing, buttoning, stapling, gluing or other fastening methods of the like.

Handle refers to a supporting element such as, but not limited to, a lever, an arm, a holder, a hanger, a bar, a rod, a pole, a stick, a staff, a shaft, a rail, a post, a dowel, a baton, a stake, a duct, a pipe, a tube, a cylinder, a hose, a roll, a shank, a boom, a cantilever.

Other objects, advantages and features of the present invention will become more apparent upon reading of the following non restrictive description of embodiments thereof, given by way of example only with reference to the accompanying drawings.

### BRIEF DESCRIPTION OF THE DRAWINGS

Various additional objects, features and attendant advantages of the present invention will become more fully appreciated as the same becomes better understood from the following detailed description and accompanying drawings wherein like reference numerals represent similar or identical components throughout the several views and wherein:

FIG. 1 illustrates the general function of an embodiment of the apparatus comprised of a bag carrying assembly comprising a bag-carrying arrangement for a disposable, carryable, perforated bag that is attachable to a fluid displacement device such as a hand-held blower/vacuum via a connector. As shown, the operator collects leaves directly into a large bag and disposes of them in the same bag made of inexpensive biodegradable material.

FIG. 2 is a side view of an embodiment of the apparatus showing a disposable leaf bag having holes located in at least half of bag upper section. The bag-carrying assembly has a bag-carrying arrangement comprising two adjacent seams that create an inlet or a casing arrangement for receiving a support member such as a hollow pipe or a rod-like handle to support and carry the bag by a bag-carrying member such as a shoulder strap during both the blower/vacuum operation and after for handling the bag in an autonomous way. The inlet is located adjacent to a fluid opening that provide internal access to the bag. The view shows also a connector inside a bag opening that is adjacent to said bag-carrying arrangement. The borders of the bag opening are secured to the connector using a securing member such as a resilient band.

FIG. 3 is a side-view of an embodiment of the perforated bag which comprises three seams; two seams forming a bag-carrying arrangement comprised of a first upper seam that provides in cooperation with a second lower seam an inlet or a casing arrangement for receiving a support member such as a handle to carry the bag. An insertable support member of a rod-type handle is also shown in FIG. 3. The second long lower seam closes substantially the bag top and ends with a downward portion leaving room for an opening arrangement. The third seam closes the bag bottom.

FIG. 4 is a side-view of a disposable perforated bag that has a bag-carrying arrangement comprising an inlet defined between two adjacent seams; a first upper seam is discontinued, in-between, by an aperture for exposing an attachment means of the elongate support member that carries the bag using a bag carrying member such as a strap; the second lower seam has an upward slanted arrangement; the first and second seam cooperate to form an inlet configured to receive the support member shown above the bag which comprises a securing member such as a resilient band.

FIG. 5 is a side-view of an alternate bag design with a bag-carrying arrangement that has a single upper seam with a downward portion to configure a large opening for receiving an elongate rectangular connector or a discharge portion of a fluid-displacement device such as that of a blower/vacuum.

FIG. 6 is a side-view of a bag design that has a bag-carrying arrangement with a single upper seam having a downward portion to configure a narrow opening for receiving a connector or a discharge portion of a fluid-displacement device; the bag has a grid of perforations located mainly at bag upper portion.

FIG. 7 is a side-view of a bag carrying assembly comprising three elements; first a vented bag having a bag-carrying arrangement with an inlet created between an upper seam adjacent to an opening and an elongate C-shaped lower double-seam; second a support member having a band that forms a retractable loop and third a bag-carrying member such as a strap with a hook.

FIG. 8 shows a side-view of the bag carrying assembly of FIG. 7, and particularly how the support member is inserted through the bag opening into the inlet.

FIG. 9 shows again a side-view of the bag carrying assembly of FIG. 7, and particularly how the outer borders of the bag opening are tucked into the expanded loop of the support member and how the hook of the bag-carrying member attaches outwardly to the exposed aperture of the elongate support member.

FIG. 10 is a side view of a collection bag that incorporates its own dust cover having a large central upper opening flanked by a pair of side-seams. In this embodiment, while the bottom portion has the same bag-carrying arrangement than in other collection bags, the cover bag portion shares the same upper seam, the same opening giving internal access to the bag and an optional same small opening for access to an exposed portion of a support member.

FIG. 11 is a side view of the dust cover bag of FIG. 10 shown in a working position and covering a collection bag. In use, dust cover is first turned upside-down over the collection bag until the jointly shared bag fluid opening becomes exposed and ready for receiving a support member such as one shown in FIG. 8; the pair of side-seams on dust cover acts as catchment preventing said bag from flying off during use of the collection bag. An optional small opening provides internal access to an exposed aperture on a support member.

FIG. 12 is a side view of a stand-alone dust cover bag for a fluid displacement device mountable over a collection bag. Similar to a collection bag, this dust cover has a bag-carrying arrangement comprising an upper seam adjacent to an opening configured to receive the discharge portion of a fluid displacement device or that of a connector; this bag has a large bottom central opening flanked between a pair of two bottom side-seams; also is shown a small bag opening on the upper seam for providing internal access to an aperture of a support member.

FIG. 13 is a side view of a wearable collection bag for a fluid displacement device wherein the bag incorporates its own bag-carrying member. This wearable bag incorporates a bag-carrying arrangement, a bag-carrying member in the form of a sleeve-less coat or a shopping bag with long handles, and a central-opening configured to receive the discharge portion of a fluid displacement device or that of a connector.

FIG. 14 is a side view of a fully enclosed, vented bag featuring a universal size opening wherein the bag-carrying arrangement has a removable portion providing internal access to the bag and wherein the opening size is determined by the extent of tearing of the strip located just above and along the tearing line to fit the perimeter of a selected fluid-displacement device discharge portion or that of a connector. For wide openings, the strip may be used as a tie to close a bag. The bag has perforations located, optionally, over the entire bag surface.

FIG. 15 is a close-up side-view view of another fully enclosed, vented perforated bag that has a removable portion providing internal access to the bag. In this embodiment, the bag-carrying arrangement includes a partial tearing line next below the lower seam, extending a distance covering the open space provided for the bag-carrying arrangement. As in FIG. 14, the extent of tearing of a strip located just above and along the tearing line determines the width of a desired opening size that best fits the perimeter of a discharge portion of a fluid displacement device or of a connector.

FIG. 16 is a cross-sectional view of a an embodiment of a support member of the bag-carrying assembly comprising a securing-member configured like a wide jaw alligator-type clamp hingeable from the top with an aperture for receiving a bag carrying member.

FIG. 17 is a cross-sectional view of an embodiment of an elongate support member of the bag-carrying assembly configured like an alligator-type clamp hingeable from the side with two side-arms to embrace and secure a bag of the invention. Furthermore, FIG. 17 shows a lock mountable over the elongate clamp that has an aperture for receiving a bag carrying member such as a strap.

FIG. 18 is a cross-sectional view of an embodiment of an elongate support member configured like an alligator-type clamp hingeable from one side with two arms to embrace and secure the bag-carrying arrangement of a paper or plastic bag having a central-opening configured to receive the discharge portion of a fluid-displacement device or that of a connector.

FIG. 19 is a perspective view of the support member of FIG. 18.

FIG. 20 is a perspective view of an elongate support member (FIG. 20A) having at one end a band-type securing member via a universal joint with a close-up view in FIG. 20B.

FIG. 21 is a perspective view of a vented paper bag that has a bag-carrying arrangement comprising an inlet formed by an upper seam that includes a small aperture in-between, and a lower seam adjacent to a side-opening formed by reversing the folding direction of a paper bag side-wall.

FIG. 22 is a cross-sectional view of a support member comprising a hollow elongate member and a securing-member comprising a band, one end forming a retractable loop and having a stopper, the opposite end mounted to a biasing member within the elongate member.

FIG. 23 is a cross-sectional view of the hollow elongate portion of the support member of FIG. 22 wherein one end of a band-like securing-member forming a retractable loop is affixed to the front outer side of the elongate member, and the opposite end, passing through the hollow member, has a lockable linear ratchet, manually retractable to secure a bag about the discharge portion of a fluid displacement device or of a connector.

FIG. 24 is a side view of an elongate support member wherein one adjustable end of a band is mounted, at an outer side of a support member, and the opposite end to a tension spring located within the hollow casing of the support member so as to retract a loop, automatically, by releasing a stopper.

FIG. 25 is a top view of the elongate support member of FIG. 24 showing a closed position of the loop in dotted line and an enlarged position of the loop in continuous line.

FIG. 26 is a close-up view of the stopper affixed to the band of FIG. 25 and of the shoulder arrangement formed by a handle side-opening. A bump located under the band causes the stopper to protrude from the side-opening. By pushing down the stopper, the biased band is released securing the bag opening around the discharge portion of a fluid displacement device or that of a connector.

FIG. 27 is a perspective view of an elongate support member referred also as a universal handle, similar to the handle of FIG. 22, which comprises a hollow casing enclosing a securing member such as a band, having one end forming outwardly a loop and the opposite end being biased by a tension spring. Also shown is a stopper protruding from a side-opening of the hollow casing and a protruding aperture forming a ring to which may be clipped a bag-carrying member such as a strap having a hook member.

FIG. 28 is a perspective view of an elongate support member comprising a securing-member such as a collar for securing a bag opening around a discharge portion of a fluid displacement device affixed to an elongate member such as a rod-like handle that is receivable by an inlet of a bag-carrying arrangement. The support member cooperates with a carrying-member. In this embodiment, the collar comprises further a deflector for deflecting projectiles downward inside the bag.

FIG. 29 is a perspective view (photo) of a bag-carrying assembly comprised of the handle/collar of FIG. 28 supporting a plastic bag from inside a bag-carrying arrangement, with the borders of the bag side-opening tucked inside the collar portion of the handle which in turn is mounted over the discharge portion of a blower/vacuum. The handle is carried by a strap mountable to a hook on said blower/vacuum.

FIG. 30 is a perspective view of a bag-carrying assembly comprising a perforated bag of FIG. 3 comprising a bag-carrying arrangement and an opening adjacent to it wherein the opening is attached to a rectangular-shape discharge portion of a fluid-displacement device or to a connector by means of a securing-member such as a resilient strap fastener. The bag-carrying arrangement is configured to receive an S-shaped hanger-type support member carriable by a bag-carrying member such as a shoulder strap or a hook means positioned on a fluid displacement device.

FIG. 31 is a perspective view of a bag-carrying assembly comprising a perforated bag having a bag-carrying arrangement with an adjacent opening wherein the bag is supported by a clamp-type elongate support member such as an alligator-type clamp having wide jaws hinging from the top for carrying the bag during and after the vacuum operation for handling independently and autonomously the bag when it is dismounted from the discharge portion of the fluid-displacement device or connector.

FIG. 32 is a perspective view of a bag-carrying assembly comprising a perforated bag having a bag-carrying arrangement with an adjacent opening wherein the bag is supported by a clamp-type elongate support member such as an alligator-type clamp having two long jaws hinging from the side and having extension arms that embrace the discharge portion of a fluid-displacement device.

FIG. 33 is a perspective view of a bag-carrying assembly comprising a perforated paper bag provided with an inlet for receiving a handle and an opening adjacent to the inlet. The lower seam of the inlet closes substantially the bag mouth, leaving an opening providing internal access to the bag which is secured to the discharge portion of a fluid-displacement device by a clamp-type arrangement that cooperates hingingly with the handle.

FIG. 34 is a perspective view of a vented paper bag having the upper borders of a central opening in the bag being delimited by an elongate dent cut on bag front wall so that when the bag upper seam is bonded full-width, in one-strike, the dented portion remains un-seamed for forming a central opening providing internal access to the bag while the two side-seams are closed.

FIG. 35 is perspective view of the vented paper bag of FIG. 36 showing the central opening created in a dented bag viewed in an open position, the opening being flanked by two bonded side-seams forming the bag-carrying arrangement of the invention.

FIG. 36 is a perspective view of a vented paper bag of the invention, the bag having a central opening flanked by two upper side-seams. As shown, the bag is supported by a clamp-type elongate support member that has two front half-jaws that hinge from the side as shown in FIGS. 18 and 19.

FIG. 37 is a schematic view of a bag-carrying assembly comprising a perforated bag configured to receive, via a flexible connector, the discharge portion of a fluid-displacement device. In this embodiment, the fluid displacement device comprises a fluid-blowing device such as a pneumatic gun, and uses a converter-type connector with a bifurcated conduit to reverse the direction of a fluid-blowing device into a fluid-vacuuming device able to entrain fluid such as air and objects therein into the bag.

FIG. 38 is a close-up, schematic view of the bifurcated conduit nose of FIG. 37 showing how a blowing air-flow from a blowing displacement device is reversed into a vacuuming air-flow using a bifurcated conduit-type connector for entraining air and any object therein into a vented bag of the invention.

FIGS. 39 is another perspective view of the bifurcated conduit of FIG. 37 showing how a converter-connector for a blowing fluid displacement device is readily converted into a vacuum device.

FIG. 40 is a schematic view of various types of C-cut perforations to vent the bag of the invention.

FIG. 41 is a perspective view of a paper bag of the invention having a central bag opening flanked by two side-seams that are clamped by a support member attached to a flexible connector providing fluid communication with a fluid displacement device (not shown).

FIG. 42 is a perspective view of a paper bag of the invention having a paper valve insert provided at one corner of the bag and an aperture on top of the bag for exposing a hookable aperture on an elongate member such as a pipe-like connector, with the connector functioning as a support member to carry the bag.

FIG. 43 is a perspective view of a paper bag of the invention having a first paper valve insert provided at one corner of the bag and a second paper valve-like insert providing a bag-carrying arrangement for receiving a support member such as an elongate handle having a hookable aperture to attach a carrying member to carry the bag.

FIG. 44 is a perspective view of a vented bag comprising an inlet which has a bifurcation defining a first and a second sub inlet so that when a fluid is blown in the second sub-inlet, a vacuum is created within the first sub-inlet providing the bag to receive fluid and any elements within said fluid into the bag.

FIG. 45 is a perspective view of a connector for a fluid displacement device configured as a conduit-inlet with a bifurcation defining a first and a second sub inlet, the conduit-inlet is mountable to a bag opening so that when a fluid-blowing portion of the fluid displacement device is mounted to the second sub-inlet receiving end and blows air therein a vacuum is created within the first sub-inlet providing the connector to displace fluid and any elements within said fluid into the bag.

### DESCRIPTION OF THE EMBODIMENTS

With reference to the appended drawings embodiments of the invention will be herein described so as to exemplify the invention and not limit its scope.

Now with reference to the drawings, a bag-carrying assembly for a vented collection bag for a fluid displacement device employing the principles and concepts of the present invention will be described in detail. The bag-carrying assembly is comprised of three main cooperating elements:

a vented bag 10 having a bag-carrying arrangement 65 adjacent to an opening 50;

a support member 32, 40 having a securing member 25, 27, 100 and 120 to secure said bag opening 50 about a discharge portion 24 of a fluid-displacement device 20 or about said discharge portion 24 via a connector 25;

a bag-carrying member 80 hookable to said support member 40.

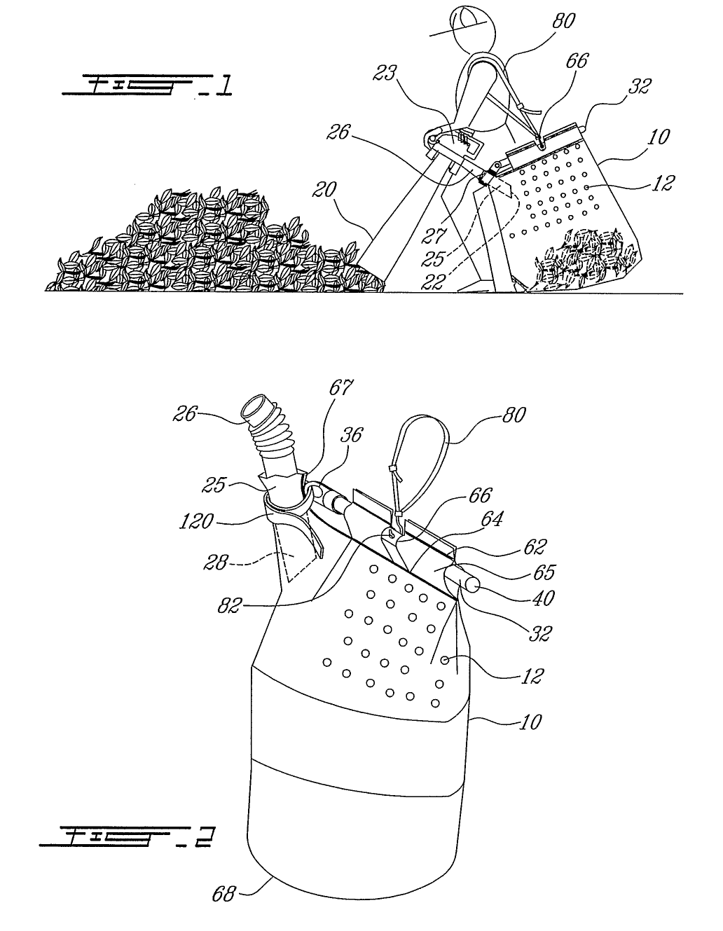

With particular reference to FIGS. 1 and 2, it can be seen that vented bag 10 receives a discharge portion 24 of a fluid-displacement device 20 such as a standard power blower/vacuum 20 operating in a vacuum mode. Said power blower/vacuum 20 includes an engine 23 that, for example, can be of the internal combustion, electric or pneumatic types. Said engine 23 is generally held by hand or by shoulder strap means. The power blower/vacuum 20 has a discharge chute 22 that directs leaves into a bag rearwardly such as in a Black & Decker or Ryobi models or frontwardly such as in a Troy-Bilt blower/vacuum model TB320BV. Collected leaves forced through said discharge chute 22 enter said perforated bag 10. Bag 10 is best made of materials traditionally used for any standardly available disposable bag formed from polypropylene, polyethylene, paper or other suitable material modified according to the requirements of the invention, but preferably of biodegradable or of compostable nature. In one embodiment, bag 10 is made of cellulose or other edible material, where bag 10 and its content can be consumed in whole by any of a variety of grazing animals. When said bag 10 is made of plastic, bag 10 comprises a thickness of approximately 1-6 mil or 0.001-0.006 inches but preferably about 1-2 mil or 0.001-0.002 inches. Bag 10 also comprises a volume consisting from the group of 40-200 liters and about 10-50 gallons.

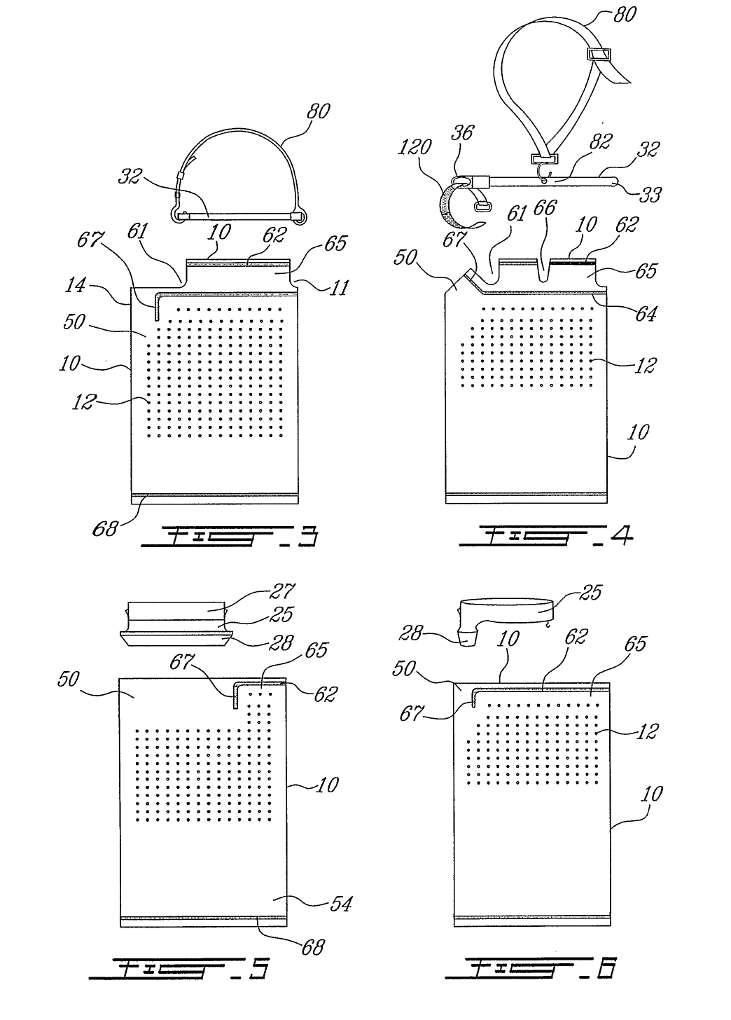

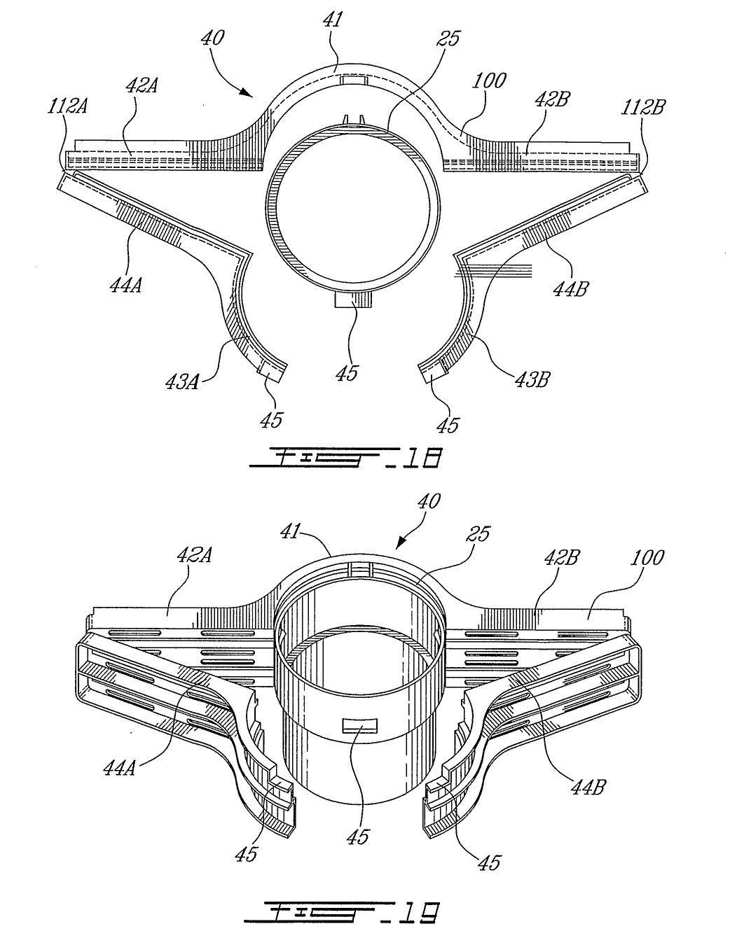

The general downward direction of projectiles created by the position of discharge portion 22 or of connector 25 provides the safety of directing any solid item picked up by the blower/vacuum 20 and ejected via the chute, to be safely projected downward, toward the ground. The bag 10 is not encased nor supported at its bottom. Bag 10 is carryable by a bag-carryable member such as by a shoulder strap 80 having two ends mountable at two separate locations 82 and 84 (see FIGS. 3,13 and 14) or said two ends joint together and mountable at a single more central location 81 and 82, on support member 32 and 40. In all embodiments of the invention, after bag 10 is fully loaded, bag 10 may be fully detached from discharge portion 24 of any fluid-displacement device 20 or from any connector 25 and autonomously and independently moved, transported, lifted or dragged using the bag support member 40 using such as handle 32, 100 and using the shoulder strap 80 of the invention (see FIG. 12). In other embodiments of the invention (see FIG. 13), autonomous handling of bag 10 is achieved using support member 40 configured as an elongate alligator-type clamp 100 supporting bag 10 outwardly or as an elongate handle 32 supporting bag 10 from inside.

Support member 40 may be formed from materials selected from the group of aluminum, plastic, metal, wood, resilient material and combinations thereof.

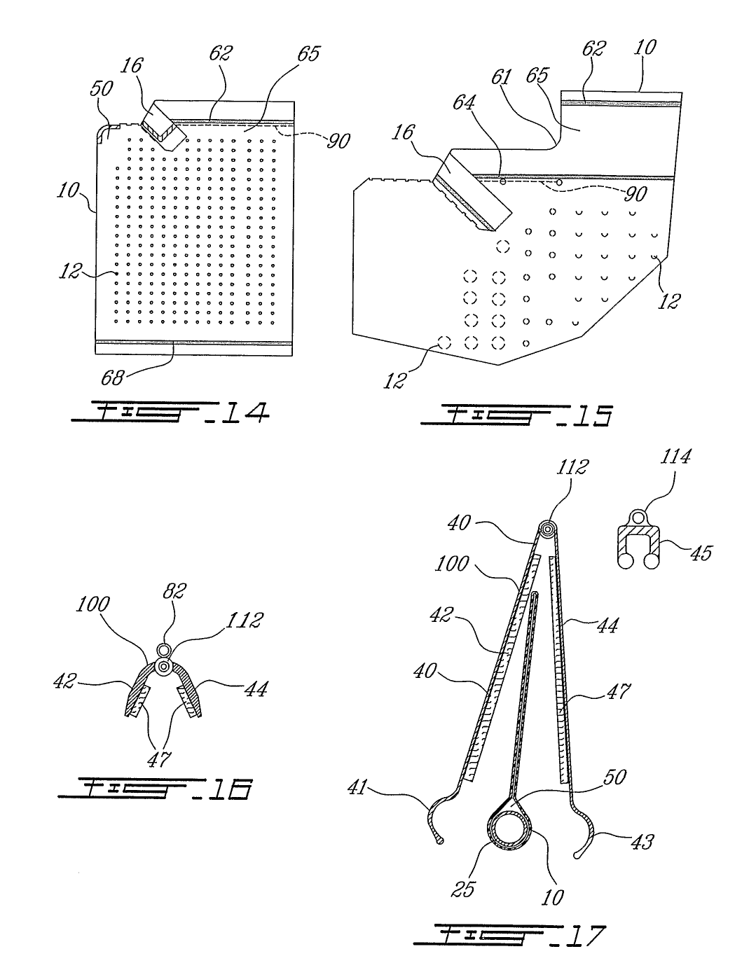

In multiple embodiments of the invention (see FIGS. 1, 2, 3, 4, 11 and 14), the bag-carrying assembly comprises a bag support system that is incorporated as part of the bag configuration wherein an outside support member 40 such as a handle 32 is inserted into bag 10. In such a configuration, bag 10 comprising a bag-carrying arrangement 65 located in top portion of the bag 10 combines the position of an upper seam 62 adjacent to a lower seam 64 to create, inside bag 10, an inlet or a sleeve arrangement. Said inlet enabling insertion of a support member 40 such as an elongate handle 32 configured as a hollow casing or a pipe. The length of said upper seam 62 may vary in different embodiments of the invention.

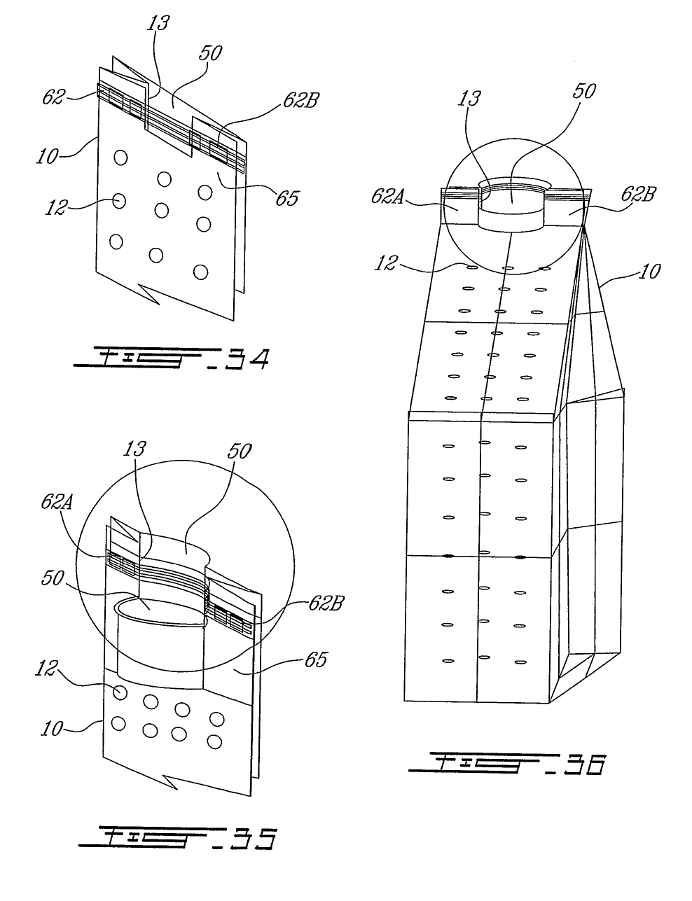

In an embodiment (see FIG. 31) upper seam 62 extends from bag one side to at least one quarter of bag 10 other side, the remaining part of seam 62 left open enables to configure an opening 50 for receiving a discharge portion 24 of a fluid displacement device 20 or to said discharge portion 24 via a connector 25 for displacing fluids such as air, gas, liquids or a combination thereof inside said bag 10, so that flow of a entrains elements therein. In this embodiment, bag 10 has three generally horizontal seams:

a first upper seam 62, part of a bag-carrying arrangement, for receiving, as described earlier, an elongate support member 40 such as a hollow handle 132, a rod-like element 33, a hanger-type handle 35 or a pipe 37 extending from bag distal end to a distance at least one quarter of bag width. Optionally, a small side cut 11 on bag one end or both ends, opens the way for supporting said support member 32 from inside said bag-carrying arrangement 65; in one embodiment, a small opening 66 is created along upper seam 62 for exposing a portion of the elongate support member 32 having an aperture 86 so as to be mountable by a hook member 81.

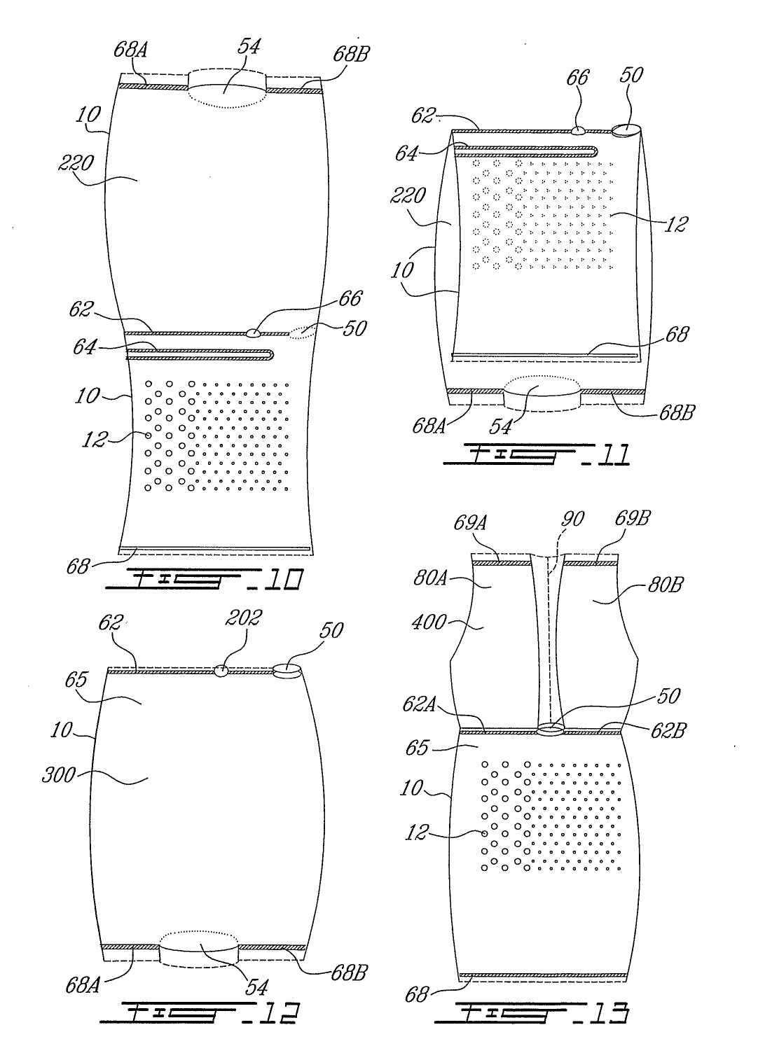

A second lower seam 64, parallel and adjacent to said first upper seam 62, located at approximately 2-15 cm lower than said upper seam 62, closes substantially bag mouth from bag one side to bag other side, leaving a non-seamed space for an opening 50 of approximately 10-60 cm in width. In an embodiment of bag 10, the generally horizontal lower seam 64 ends with a downward portion 67 providing for said opening to comprise a downward arrangement of approximately 1-20 cm (see FIG. 3). The opening 50 is bordered on bag proximal end by bag walls 14. In other embodiments, bag opening 50 is centrally located and is flanked by a pair of two side-seams 62A and 62B. The relatively small opening 50 provides a pre-sealed arrangement that eliminates substantially the need for tying a loaded bag before disposal. In yet some other embodiments (see FIGS. 7, 8 and 9), lower seam 64 takes the shape of a 270 degrees flipped U, wherein the two very long horizontal arms of said U seam expose, close to opening 50, a rounded seam able to withstand and distribute evenly fluid pressure, when bag 10 is inflated. This rounded configuration eliminates the possibility of creating a weak point in bag 10 rather than having a straight-line seam 64 exposing the sharp edge of said line to withstand fluid pressure.

A third bottom seam 68, extending bag 10 full width, seals the bag bottom.

In use, a fluid such as air displaced through the discharge portion 24 of the fluid-displacement device 20 or through connector 25 entrains leaves 30 and inflates bag 10 to its fullest capacity, inflating bag 10 with air so as to entrain elements such as leaves 30 inside bag 10 while air is filtered out by the perforated holes 12. To properly vent exiting air, an appropriate number and concentration of holes is punched in at least half of bag upper section to avoid burst of the plastic or paper bag 10 by excess air pressure generated from the fluid-displacement device.

Conveniently, the bag-carrying assembly has the advantage that, as bag 10 fills with leaves that first clog bottom holes by gravity, air is forced to exit from bag top holes 12. However, as collected leaves get packed up and reach discharge pipe 24 exit level or that of connector 25, they start to obstruct air and leaf entry into bag 10 creating a back-pressure, a self-compensating condition that effects and reduces air intake of the power vacuum 20.

Bag 10 of an embodiment of the bag-carrying assembly has plural perforated holes 12 for air venting, containing about 1-8 holes per square centimeter or about 2-20 holes per inch, said holes 12 punched or pressed into bag 10 with perforations configured in shapes such as pinholes, C-cut, butterfly-cut or O-cut or slits as shown in FIG. 42, during manufacturing.

For collecting leaves or other organic and non-organic vacuumable elements, bag hole positioning on collection bag 10 follows a pattern of hole sizes and hole numbers matching the nature of elements to be vacuumed, their degree of wetness, the accepted amount of dust allowed to escape from holes 12 and more importantly the amount of air produced by a selected fluid-displacement device 20. For example, for collection and bagging of damp leaves 30 in bag 10 known as giant-size bag for the garden, size 79×117 cm or 31×46 inch, a minimum of 300-500 holes of 2-6 mm in diameter, or slits having an equivalent surface area, located in at least on half of bag upper section, on both sides, is recommended. This allows to match approximately an air discharge of 200-350 CFM generated from a standard blower/vacuum having, for example, an electrical motor of about 1500 Watt attached to a connector pipe of approximately 72 mm in cross-sectional diameter. For collection of smaller size elements than leaves, such as seeds or peanut trash in a food-processing factory, when using the same power vacuum 20, it is recommended to use bag 10 having a minimum of 1000-4000 smaller pin-holes of preferably 0.5-2 mm in diameter. Generally, too many holes weaken bag strength while insufficient number of holes reduce the efficiency of the apparatus, putting too much pressure on seams. Similarly, too big size holes let too much dust escape, a matter of lesser importance when vacuuming leaves in an open garden environment than when vacuuming dry elements in a closed environment such as in a factory. Bag 10 is generally constructed with seals and seams produced by a process selected from the group such as local melting with a hot surface, heat sealing, sewing, buttoning, stapling, gluing or other fastening methods of the like.

For applications requiring control of dust during collection of dry or dusty elements or for collection of small elements, collection bag 10 is covered, in an embodiment of the invention, with a bag 300, referred to as dust cover, that is mountable over collection bag 10 as shown in FIGS. 10, 11 and 12; In this embodiment, dust cover bag 300 (see FIG. 12) of slightly larger size than bag 10, is configured to be mountable to a fluid displacement device 20 and is comprised of a bag-carrying arrangement 65 having a single upper seam 62 for receiving a bag support member 32, 40, 100 and an adjacent top opening 50 for receiving a discharge portion 24 of a fluid-displacement device 20 or to said discharge portion 24 via a connector 25. Furthermore, a small opening 66 is left open in seam 62 for exposing a portion of the elongate support member 32, said portion having the form of an aperture 86.

As shown in FIG. 12, to provide air venting from bag 300, bottom seam 68 comprises a central bottom opening 54 flanked between a pair of two side-seams 68A and 68B. In use, collection bag 10 is inserted into dust cover bag 300 through bottom opening 54 so as to have both bags 10 and 300 top fluid openings 50 match each other's borders. The bag-carrying assembly comprises, in this embodiment, a bag support member 32 which is inserted into the bag-carrying arrangement 65 of bag 10 which now is super-imposed by the bag-carrying arrangement 65 of bag 300. Both borders of bag openings 50 are jointly tucked into loop 125 of a securing member of an elongate support member 32, 40. Said openings 50 are jointly secured about discharge pipe 24. The exposed hookable part 86 of support member 32 protruding through bag 10 at small opening 66 of bag 300, is mounted to a bag-carrying member 80 having a hook 81. Air and dust escaping from perforations 12 of collection bag 10 are forced downward, along and inside bag walls 14 of dust cover bag 300 to escape from central bottom opening 54. The pair of the two side-seams 68A and 68B create a bottom wall preventing bag 300 to slide off from bag 10 due to air pressure exiting from holes 12. In this embodiment, both bags 10 and 300 are inexpensive and can be made of disposable material. However, dust cover bag 300 is preferably made of re-usable material. Bag 300 may also be made of standard fabric, filter paper or of other fibrous material.

In another embodiment of the invention, dust cover bag 220 is manufactured as integral part of collection bag 10 as shown in FIG. 13. While having the same configuration as bag 300, bag 220 is generally made of the same size or preferably slightly larger than bag 10. Similar to bag 300, bag 220 comprises a central bottom opening 54 flanked between a pair of two side-seams 68A and 68B. In use, dust cover bag 220 is turned upside starting from side-seams 68A and 68B so as to fully cover collection bag 10 and to have bag opening 50 exposed. As in previous embodiment, a bag support member 32 inserted into the bag-carrying arrangement 65 of bag 10 shares the same upper seam 62 as that of bag 220. Borders of bag opening 50 are tucked into securing member forming loop 125 as in other embodiments. The exposed hookable part 134 of support member 40 protruding through small opening 66 in bag 10 and through small opening 202 in bag 300 is mounted to a bag-carrying member 80 having a hook 81. Fluid such as air and dust escaping from perforations 12 of collection bag 10 are forced downward, along and inside bag walls of dust cover bag 220 in order to escape from central bottom opening 54. The pair of two side-seams 68A and 68B prevent dust cover 220 to slide off bag 10 due to air pressure exiting from holes 12.

When using bag 220 or bag 300, the associated bag 10 serves as an inner liner for said bag 220 or said bag 300.

When dust covers bag 220 and bag 300 are used for collection and for pre-packaging of environmental, agricultural or commercial elements, after being used to deflect vented air or dust, said covers 220 and 300 may be used to fully seal content of bag 10, using bag covers 220 and 300 to act as sealable envelopes, requiring minimal sealing of upper opening 50 and of bottom opening 54.

In an embodiment of bag 10 of the bag carrying assembly, a wearable bag 400 (see FIG. 13) is provided for a fluid displacement device 20, said bag 10 wearable like an apron in front of a user or like a long and low pack sac in the back of the a user having a big pocket for vacuuming elements therein. Said bag 10 incorporating its own bag-carrying member configured like as straps 80A and 80B with tearing a line 90 to separate said two straps. This wearable collection bag 10 incorporates a bag-carrying arrangement 65, a bag-carrying member in the form of a sleeve-less coat or a shopping bag with two long handles 80A and 80B formed by bag-carrying seams 69A and 69B, and a central-opening 50 flanked by a pair of side-seams 62A and 62B, said opening 50 providing access to bag 10 and configured to receive the discharge portion 24 of a fluid displacement device 20 or that of a connector 25.

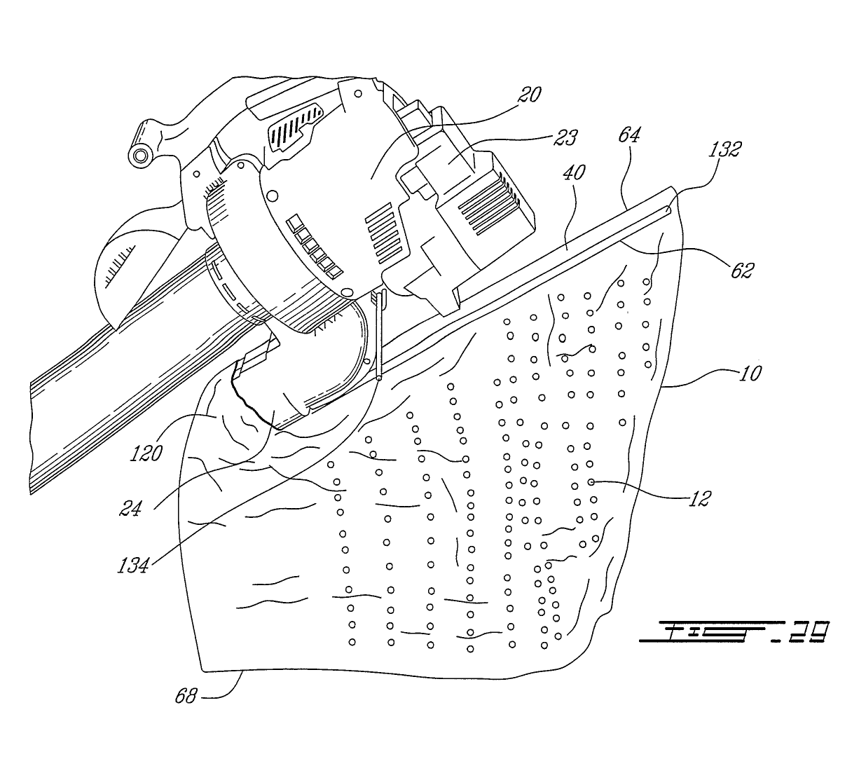

In an embodiment of a bag-carrying assembly (see FIGS. 22, 23, 24, 25, 26, 27 and 28) a support member 40, also referred to as a universal handle 132, is configured as a hollow elongate member 132 shaped like an elongate round or square pipe. Said elongate member 132 comprises a spring-loaded retractable securing member 120 selected from the group of bands 124, straps, strings or fasteners having a first exposed portion 122 forming outwardly a loop 125 and a second enclosed portion within said elongate member 132, the end of said securing member attached to a tension spring 200 located in the hollow cavity of the support member 40.

When said loop 125 is pulled outwardly biasing said tension spring 200, a stopper 160 on said band 124, protrudes, pushed upward by bump 31, said stopper 160 comprising a protrusion adapted to abut a shoulder 136 positioned on the support member 40 so as to position the securing member 120 against the spring 200. In use, loop 125 is pulled to expand until protrusion of stopper 160 abuts shoulder 136. With a fully expanded loop 125 support member 40 is inserted first through bag opening 50 into bag 10 and then more deeply into bag inlet 65 formed between upper seam 62 and lower seam 64. When fully positioned inside bag 10, bag borders of opening 50 are tucked into loop 125. At this point, the discharge portion 24 of a fluid displacement device 20 or that of a connector 25 is inserted into opening 50. On pushing down to release stopper 160, spring 200 retracts loop 125 and tightens borders of bag opening 50 round said discharge portion 24 or round said connector 25. A hook member 82 or a clip on bag-carrying member 80 is hooked to a corresponding aperture 134 located on a central location on said elongate support member 40.

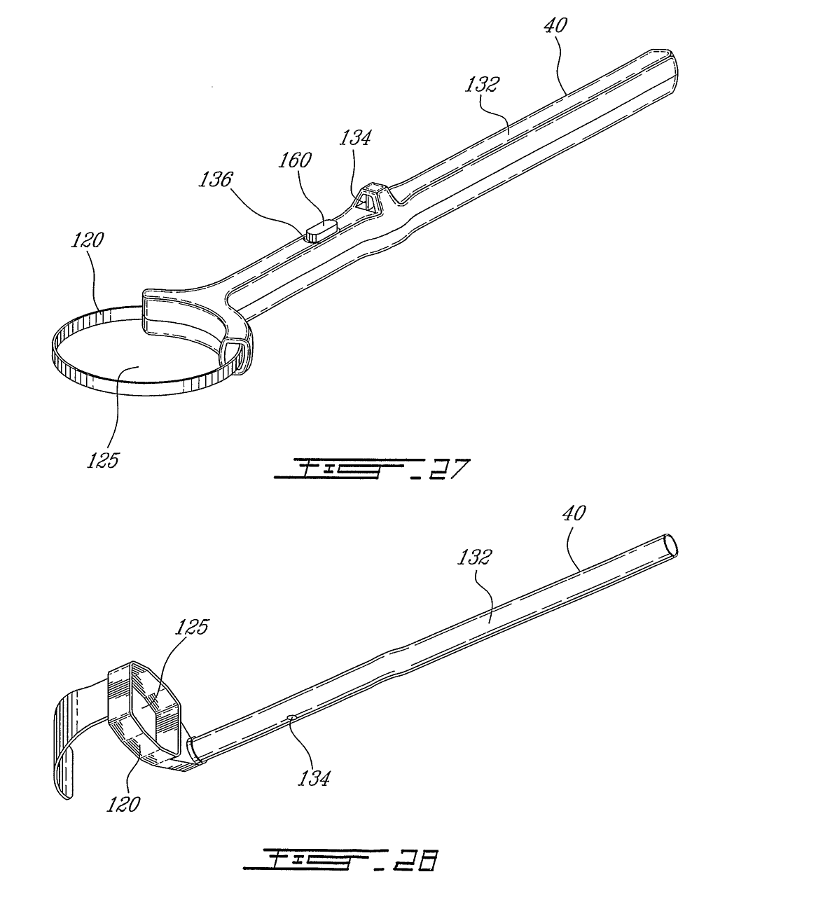

In an embodiment of the bag-carrying assembly (see FIG. 23) comprising a support member 40 configured like a hollow elongate casing 132, said support member 40 encloses a manually retractable securing-member 120 such as a band 122, one exposed end forming outwardly a loop 125 and, the other band end, forming a manually retractable band having a releasable lock arrangement 126 cooperating with a linear ratchet arrangement 128.

Yet, in another embodiment of a bag-carrying assembly (see FIG. 14), bag 10 comprises of a fully enclosed, vented bag 10 featuring a seam 62 comprising a size selectable universal opening 50 wherein the bag-carrying arrangement 65 is supported outwardly by a clamp-type support member 100 and wherein said bag 10 comprises a removable portion 16 providing internal access to bag 10 and wherein the size of opening 50 is determined by the extent of tearing of strip 16 located just above and along a tearing line 90, so as to match the length of the perimeter of a selected discharge portion 24 of a fluid-displacement device 20 or that of a connector 25. For wide openings 50, strip 16 may be used as a tie to close bag 10. Bag 10 has perforations 12 located either on the entire bag surface or preferably in bag upper portion. Such perforations 10 may be selected from the group of C-cuts, butterfly-cuts, O-cuts, oblique slits and cuts of the like to maximize air exit while minimizing exit of dust and element from holes 12.

In another embodiment of the bag-carrying assembly (see FIG. 15), bag 10 comprises another fully enclosed, vented bag 10 featuring a selectable universal size bag opening providing internal access to bag 10 wherein the bag-carrying arrangement 65 receives an insertable support member 40. The bag-carrying arrangement 65 of bag 10 comprises a partial-length upper seam 62, a full-length lower seam 64 and a partial-length tearing line 90, said tearing line 90 located just below said lower seam 64 and extending to a length equivalent to the open space adjacent to upper seam 62. The tearing of perforation line 90 provides a bag opening 50 to match the perimeter of a discharge portion 24 of a fluid displacement device 20.

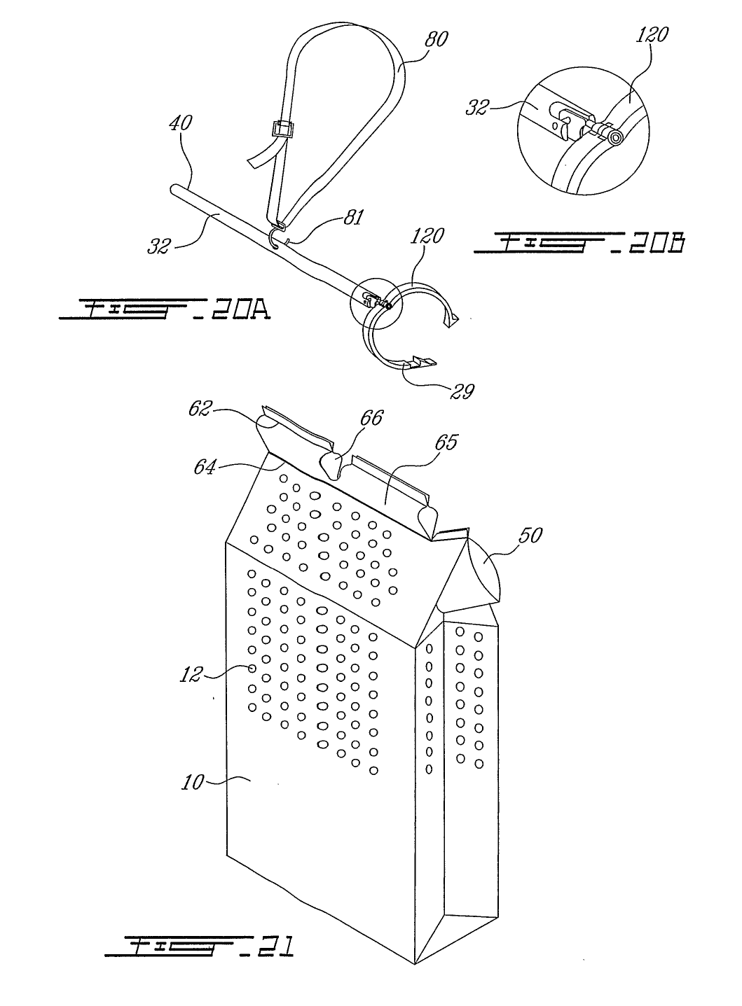

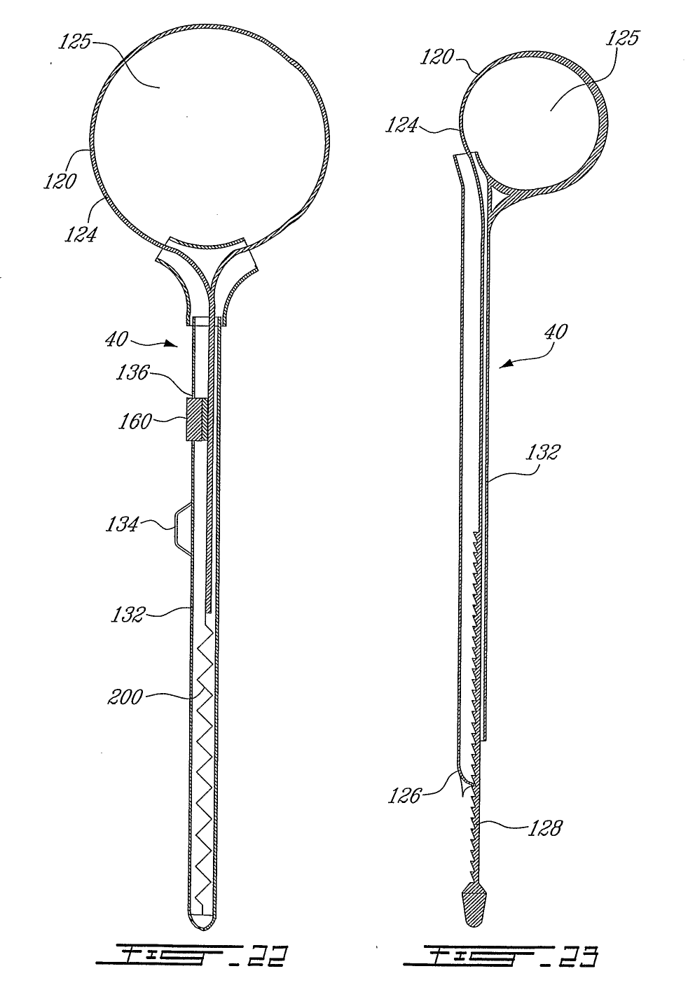

In a group of embodiments of the bag-carrying assembly of the invention, with individual parts or the complete assembly shown in FIGS. 16, 17, 18, 19, 31, 32 and 34, a support member 40 is configured like an alligator-type clamp 100 for clamping outwardly bag 10. Securing members 42, 44 of said clamp 100 pivot round a single hinge 112 as shown in FIGS. 16 and 17, or about two hinges 112A and 112B as shown in FIGS. 18 and 19. Hinges 112, 112A and 112B are selected from the group of hinges located in positions providing clamping functions on a clamp upper portion (as shown in FIGS. 16, 31), on a clamp one side (FIGS. 17, 32) or on a clamp two sides (FIGS. 18, 19). In these embodiments, the hinging position depends on the location of the central bag opening 50 in various embodiments of bag 10.

Said alligator-type clamp 100 comprises an aperture 82 and 114 located on support member 40 (see FIG. 17) for receiving a clip 45 mounted on a bag carrying member 80, said clip 45 mountable over aperture 82 and 114 on elongate support member 40, said clip 45 configured like a C-shaped clip selected from the group of slidable, hingeable and lockable clips.

Grids for localizing holes 12 (see FIGS. 1, 7 and 14) are selected from grids wherein holes 12 are concentrated in the upper portion of bag 10, in one side of bag 10 or on the entire surface of bag 10. The preferred grid provides an optimized air venting primarily when bag 10 reaches its full capacity. Furthermore, avoiding to position holes 12 in bag 10 lower portion eliminates the possibility of having wet materials collected in bag 10 to release their liquids or moisture out of the bag bottom.

It is also known that because of environmental concerns and an increasing interest in composting, large size biodegradable and compostable paper bags 10 such as 18″×12″×33″ size and 30 gallons in capacity, are gaining public interest for collection and bagging of compostable materials such as leaves. However, filling paper bags 10 with leaves is cumbersome and has required enormous efforts on behalf of governments and environmentalists to convince people to use paper bags 10 as an alternative solution to ordinary plastic bags 10 or to biodegradable bags. The solution provided by the present invention resolves many limitations associated with the burdensome activity of collection and bagging of lawn debris such as leaves into traditional paper bags 10, also known as paper lawn refuse bags. Furthermore, the invention eliminates the need to tie bag 10 as in paper bags of the prior art by providing a bag 10 which mouth is substantially pre-sealed, thus allowing it to be filled to its fullest capacity, from bottom seams to its upper seam 62, unlike traditional leaf bags that require an empty space for bag closure.

In an embodiment of the bag carrying assembly comprising a vented bag 10, bag 10 is made of coarse material, such as recycled fiber and recycled paper. To provide additional strength, said paper bag 10 is selected from the group of one-, two- and three-ply paper and of wet-strength paper. Paper bag 10 has generally seams and seals selected from the group of standard sewn seams, “tape over sewn” seals—hot-melt tape over the sewing—to prevent water leakage from the bottom, wax-dipped bottoms, wax-dipped tape ends for eliminating wicking of water, staples and a combination thereof. Paper bag 10 is supported in its upper portion, by a support member 40 such as by an alligator-type clamp 100 configured to clamp bag opening 50 round discharge portion 24 and over bag-carrying arrangement 65.

In an embodiment of the paper bag 10 (see FIG. 42), bag opening 50 is comprised of a paper valve insert 51 provided at one corner of bag 10, on bag one side. Said paper valve insert 51 forms a bag-carrying arrangement 65 for receiving a support member 40, said support member 40 being incorporated in the upper portion of a pipe-like connector 25; an elevated aperture 134 on said connector 25 receives a hook member 81 of a bag-carrying member 80. Said support member aperture 134 when exposed out of bag 10 through bag aperture 66 cooperates hookingly with hook member 81.

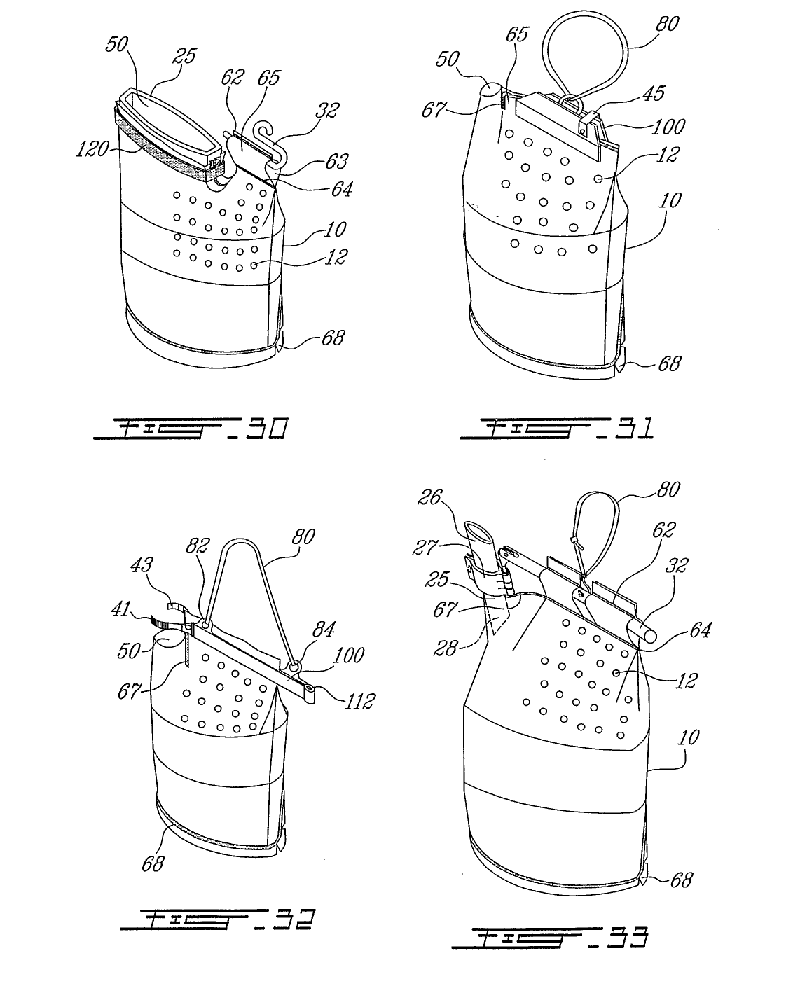

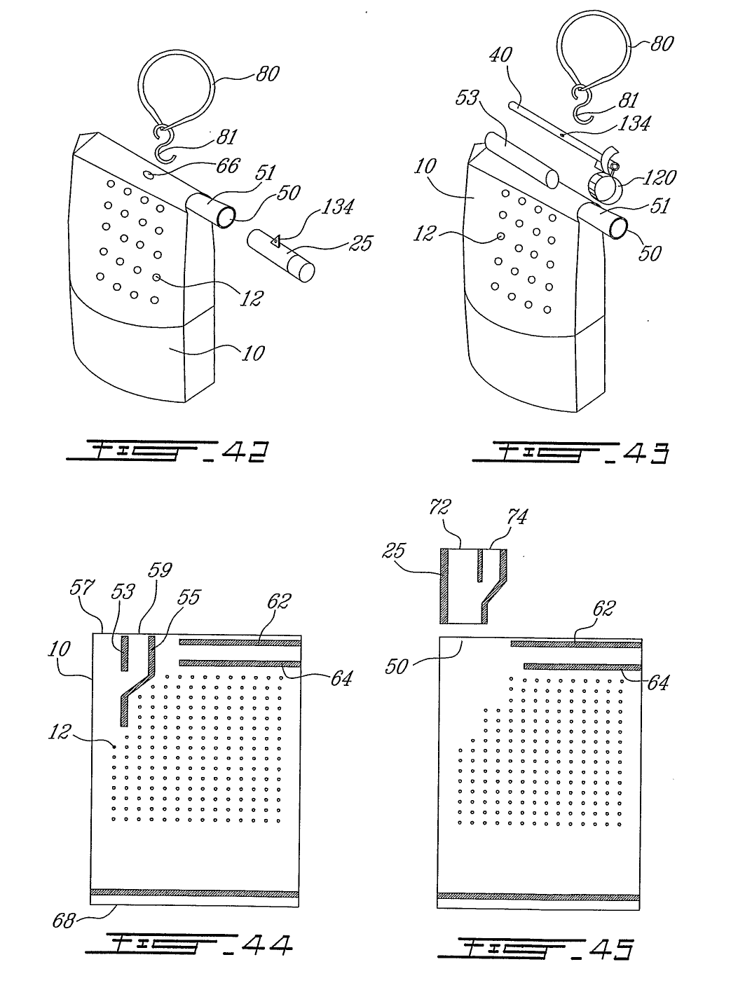

In another embodiment of the invention (see FIG. 43) paper bag 10 has a bag opening 50 comprised of a first paper valve insert 51 provided at one corner of bag 10, on bag one side, and an additional inlet 65 adjacent to said insert 51. Said inlet 65 forming a bag-carrying arrangement that may be made of a second paper valve insert 52 bonded by gluing, stapling, heat sealing or sewing means to the upper portion of bag 10. Said bag 10 is supported by a support member 40 comprising a securing member 120 and an elongate member 40 such as a hollow pipe 132 with an aperture 134 such as shown in FIG. 28. Said securing member comprising an adjustable collar or a resilient band 120.

In use for garden clean up, paper bag 10 may collect organic materials such as leaves, grass clippings, pine needles, weeds, chipped prunings and spent garden plants. When using air to vacuum elements for entraining and displacing them into a bag 10 without mulching or damaging them, plastic and paper bag 10 can be used for collection, pre-packaging or final packaging of agricultural products such as seeds, grains, beans, fruits, berries, etc. Bag 10 may also be used for environmental clean up such as for collection of animal pooh and excreta, particulates from spills, granulates used as chemical absorbents, wood chips, litter, etc. In assembly-line type activities such as food-processing plants, pharmaceutical plants or in the plastic industry, smaller size products or residues may be collected in bag 10 for storage or disposal purposes.

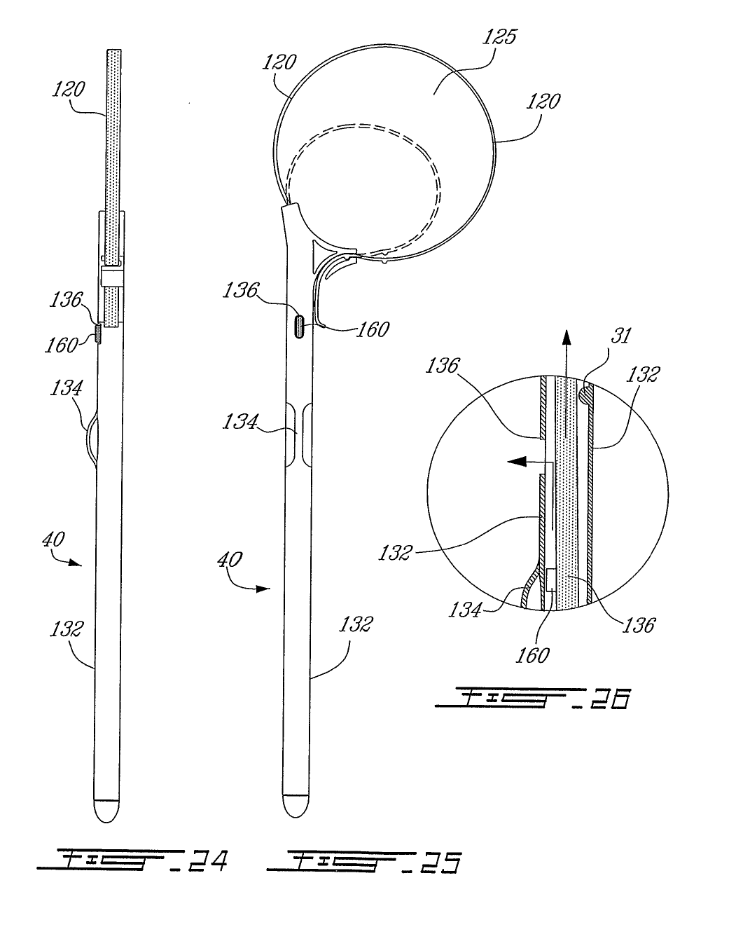

In an embodiment of the invention (see FIGS. 2, 20, 21, 34) the bag-carrying assembly comprises a vented paper bag 10 having a bag-carrying arrangement 65 that comprises an inlet formed between two generally horizontal seams, an upper seam 62 and a lower seam 64, said inlet configured to receive a support member 40 such as a rod-like handle 32 extending from paper bag distal end to a distance at least one quarter of paper bag width. A small, generally vertical, side cut 11 on bag distal end opens the way for inserting handle 32 inside and through said inlet 63; adjacent to said inlet is located a side-opening formed by reversing one of the two side-folds of paper bag 10 (see FIG. 21).

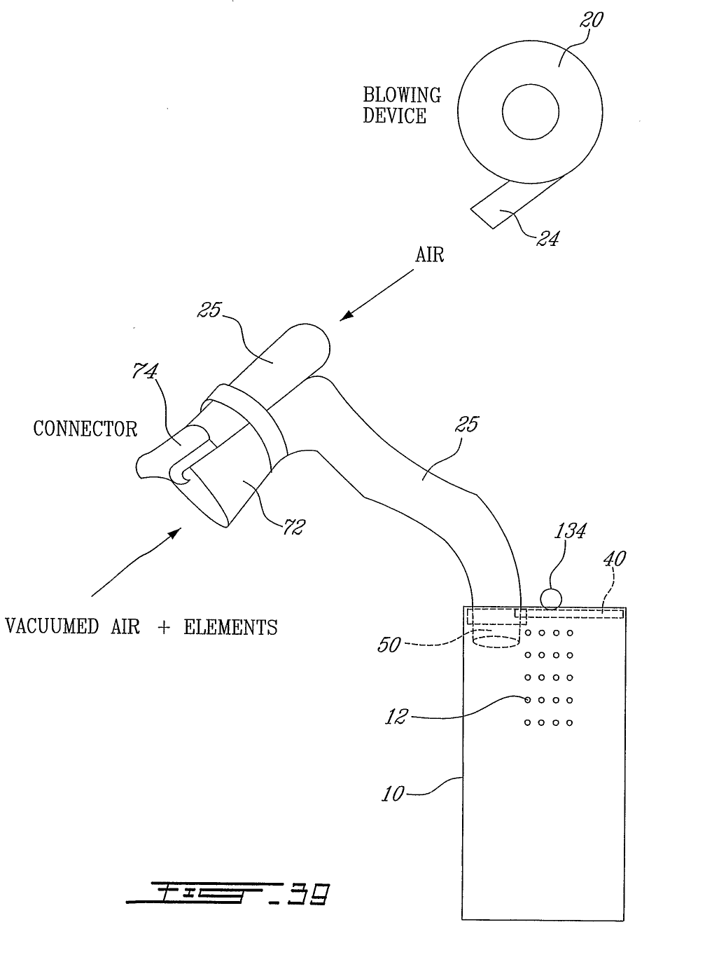

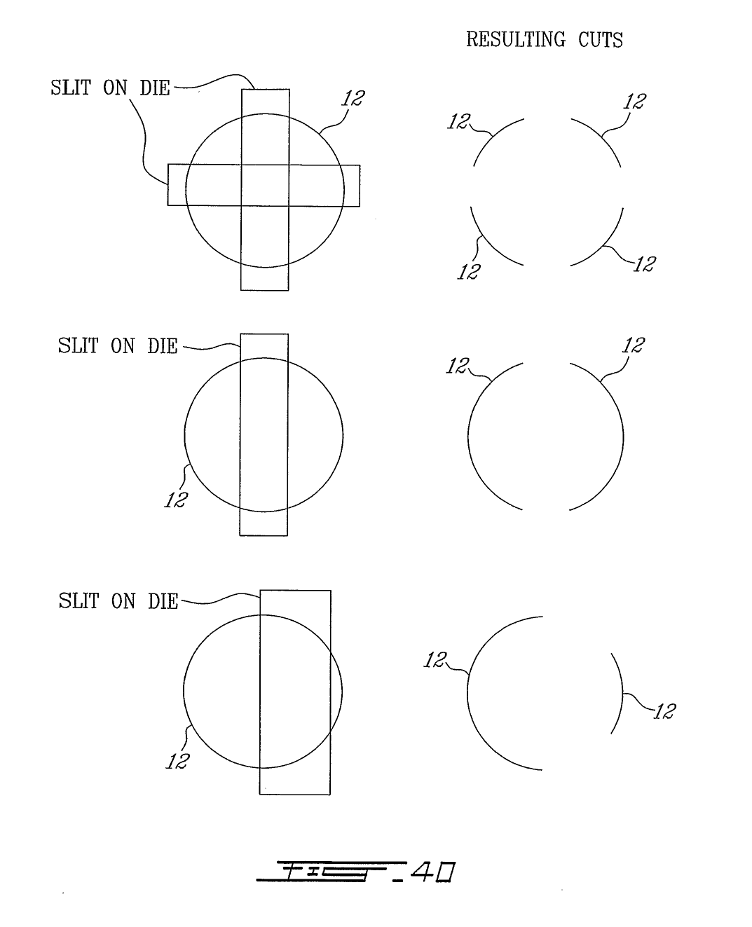

In another embodiment of the bag-carrying assembly of the invention (see FIGS. 34, 35, 36, 41) for a paper bag 10 for a fluid displacement device, paper bag 10 is vented with holes 12 and comprises a bag-carrying arrangement 65 having a central opening 50 flanked by a pair of two upper side-seams 62A and 62B.

For ease of forming said upper side-seams 62A and 62B, an elongate segment is cut off on bag front or back wall in the shape of a dent 13, said dent 13 forming a centrally-located elongate cavity of 4-7 inches long and of 0.5″-2″ deep. When sewing, gluing or sealing the bag full-width upper portion, at a distance of about 0.3″-1″ from bag top edge, in order to form upper seam 62, said elongate cut segment on bag 10 leaves the dented portion 13 un-seamed, while the action of sewing or of gluing bonds only the desired portion of seam 62 of bag 10, defining substantially the position and length of said pair of side-seams 62A and 62B.

In yet another embodiment of the invention (see FIGS. 18, 19) where bag 10 is made of paper, support member 40 of the bag-carrying assembly is configured in the shape of an elongate clamp 100 to be mounted to a fluid displacement assembly, the bag 10 comprising an opening 50 for receiving a securing member 100, said securing member 100 to secure the opening 50 about a discharge portion 24 of said fluid displacement assembly, said clamp 100 comprising:

a generally elongate alligator-type clamp 100 configured as a body comprising a middle portion 41 flanked by opposite panels 42A and 42B respectively defining end portions 112A and 112B, said middle portion 41 being mountable about at least a portion of said securing member 100;

a pair of arms 44A and 44B, each of said arms 44A and 44B pivotally mounted at one end thereof to a said end portion of a respective said panel 42A and 42B and comprising at an opposite end thereof a lockable portion 45.

The clamp body 100 defines a first half-jaw 42A, said pair of arms 44A defining a second complementary and cooperating half-jaw 44A. The clamp middle portion 41 comprises a semi-circle and said lockable portions 43A and 43B define a complementary semi-circle when mated. Each of said lockable portions 43A and 43B comprises a quarter-circle-shape collar 43A and 43B. Each of said arm 44A and 44B is hingeably mounted to said respective end portions 112A and 112B.

In another embodiment of a paper bag 10 secured by a support member 40 of the invention (not shown) configured in the shape of an elongate clamp 100 of generally of similar shape than in FIG. 18, said front arm 44A cooperates hingingly with panel 42A about hinge 112A, said hinge 112A located at an upper edge of said elongate panel 42A, similar to hinge 112 shown in FIG. 16. Similarly for said front arm 44B cooperating hingingly with panel 42B about hinge 112B. Said arms 44A and 44B having on their respective proximal ends quarter-circle-shape collars 43A and 43B so as to clamp opening 50 and bag-carrying arrangement 65 between said linear back panel 42A and front arm 44A. A lock arrangement 45 located on said partial collars 43A and 43B locks the clamp 100 to secure bag 10 in-between its jaws.

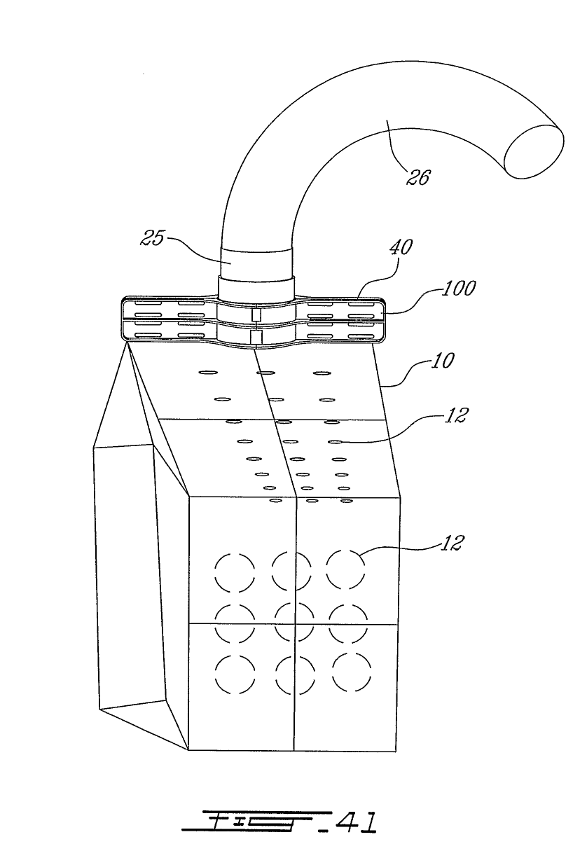

In use, an embodiment such as shown in FIGS. 34, 35, 36 and 41, the central opening 50 of paper bag 10 is first opened to receive discharge portion 24 of a fluid displacement device 24 or that of a connector 25, with side-seams 62A and 62B positioned in-between jaws (42A,44A) and (42B-44B) of said elongate alligator-type clamp 100; then front jaws (43A, 44A) and (43B, 44B) are positioned against the elongate clamp body 41 flanked by opposite panels (42A, 42B) and locked by lock 45, thus supporting the upper portion of paper bag 10 so as to provide fluid communication between fluid displacement device 20 and bag 10 via a connector 25 such as a flexible connector 26 of FIGS. 2 and 41.

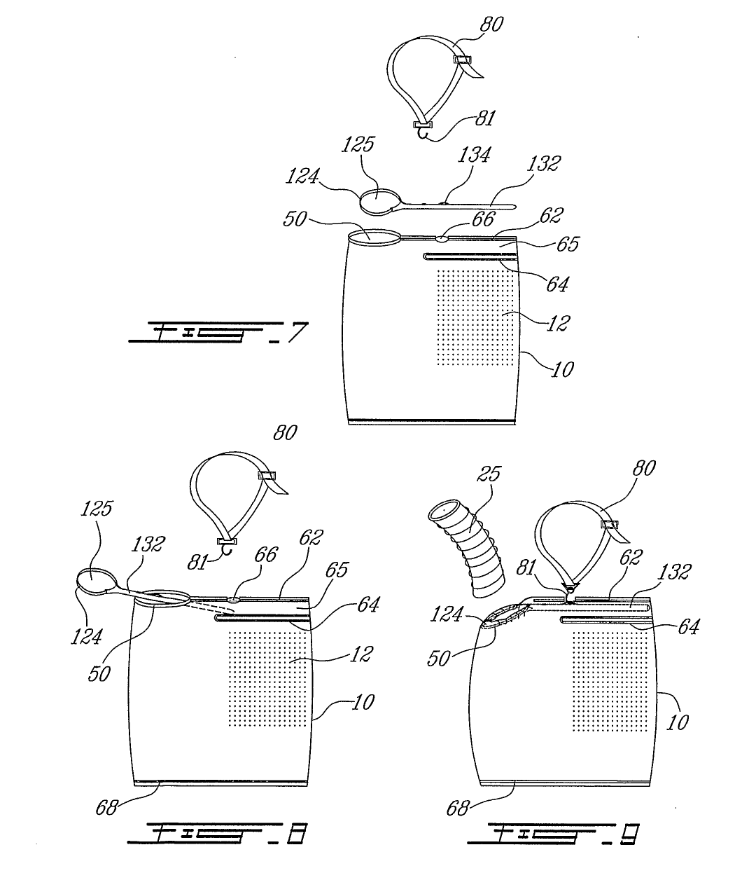

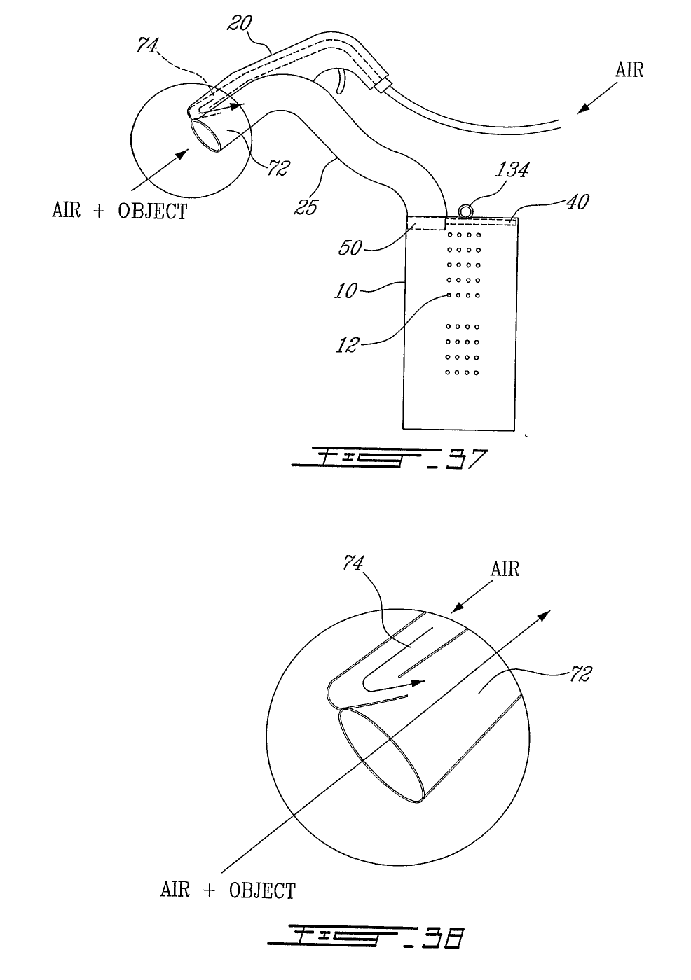

In yet another embodiment of the bag-carrying assembly (see FIGS. 1 and 2) comprising a bag-carrying arrangement 65 and an adjacent opening 50 for receiving a connector 25, said connector 25 is comprised of a connector having a sleeve end in fluid communication with the discharge portion 24 of a fluid displacement device 20, said fluid displacement device 20 having a connector discharge end 22 in fluid communication with opening 50 of bag 10. Said opening 50 being secured around connector discharge end 22 by a securing member 120 of the bag carrying assembly of the invention. Connector 25 is best made of any standardly made plastics, rubbers or materials of the like. The configuration of connector 25 is selected from the group of connectors having a wide mouth collector funneling fluid-entrained elements into a smaller round-type casing 28 (see FIG. 6), an elongate pipe-type casing 28 (see FIGS. 1, 33), a rectangular-type casing 27 (see FIGS. 5, 30), an oval-type casing (not shown), a flexible hose-type arrangement 26 (FIG. 2, 41) and combinations thereof. Connector 25 is cost effective to manufacture and requires little storage space.

In an embodiment of the bag-carrying assembly comprising an elongate support member 40, configuration of said support member 40 is selected from the group of square or of rounded shape elongate handles 32 such as a solid- or hollow-type rod or tubing 32, of hollow-type casing or tubing 132, with said handle 32, 132 having apertures 34, 36 positioned, on some embodiments, at each end of handle 32, and in other embodiments with an aperture 134 at a more central single location on said handle 32, 132. Said aperture 34, 36, 132 mountable to a shoulder strap 80. In an alternate embodiment of the handle 32, the rod- or hollow-like handle 32 is selected from the group of wood or plastic rods having two holes at rod end, small-diameter metal rods flattened at each end to contain a hole, an S-type metal hanger (see FIGS. 4 and 30), a metal pipe of the mop-handle type with a plastic hanger-hole 36 at one or both ends (see FIGS. 2, 4), a plastic pipe with a hole at each end, a hollow plastic casing with centrally located aperture 134 and combinations thereof; the length of said handle 32, 132 matching substantially the length of said bag-carrying arrangement 65 also referred to as inlet 65.

In another embodiment, bag 10 is externally secured to connector 25 by a securing member 120 selected from the group of fasteners comprised of two semi-circular hingeable elements 27 such as split ring pipe clamp (see FIG. 1, 33), fasteners having latching means 29 (see FIG. 20) such as quick release latch, over-center latch (not shown), fasteners having clamping means such as spring loaded band clamp (not shown), wrappable fasteners having resilient strap means such as rubber bands and elastic straps (see FIGS. 2, 4, 30), cord and a VELCRO band (FIG. 2, 30). VELCRO is a trademark for a fastener consisting of hooks and loops (not shown) and combinations thereof. All fasteners that have not been identified in drawings are standard fasteners that are well known to those skilled in the art.

In an embodiment of the bag-carrying assembly, a support member 40 such as a lockable clamp of the alligator type 100 supports bag 10, with clamp elements selected from the group of clamping systems shown in FIGS. 16, 17, 18, 19, 31, 32, 33 and 41 defined individually as follows. FIG. 17 shows a clamp-type support member 40 in an open position with connector 25 positioned inside bag opening 50. The inner side of the linear and long jaws 42 and 44 of said support member 40 are lined with resilient material 47 for better grip. Jaws 42 and 44 hinge round pivot 112 located on distal end of support member 40 at opposite end of bag opening 50. Support member 40 is lockable by positioning a securing member such as a U-shaped sliding lock 45 on support member arms 42 and 44. Support member 40 comprises two apertures 112 and 114 each mountable to a hook member 82 mounted on a carrying member such as a shoulder strap 80. Jaws 42 and 44 end with two respective semi-circular extension arms 41 and 43 provided to embrace loosely connector 25 without clamping said connector 25 tightly to only limit distance variations between support member 40 and opening 50. In such embodiment, a securing member such as resilient band 120 other than arms 41 and 42 secures said opening 50. In another embodiment of a support member 120, said semi-circular extension arms 41 and 43 embrace tightly connector 25. The action of limiting distance variations between the bag-carrying arrangement 65 portion from the bag opening 50 portion prevents undue tensions on plastic bag 10 when user makes wide movements with a fluid displacement device 20. In this type of support member 40, securing opening 50 to connector 25 is achieved by a securing member selected from the group of resilient band 120 (FIG. 2), VELCRO-type band 120 (FIG. 30) when securing a bag 10 made of plastic and of split ring pipe type clamp 27 for a bag 10 made of either paper or plastic (see FIGS. 20 and 33).

In another embodiment, the fluid displacement assembly of the invention comprises:

a bag 10 comprising an inlet 50 with two downward arrangements 53 and 55, said inlet 50 comprising a bifurcation defining a first sub inlet 57 and a second sub inlet 59;

a fluid displacement device 20 comprising a fluid-blowing portion 24 mountable to said second sub-inlet 59;

when the fluid-blowing portion is inserted within said second sub-inlet 59 receiving end and blows fluid therein a vacuum is created within the bag 10 providing the first sub-inlet 57 to displace fluid and any elements within the fluid therethrough into the bag 10.

In another embodiment of the invention, a fluid displacement assembly comprises a bag 10 comprising an inlet 50, a connector 25 configured as a conduit mountable to said bag inlet 50 comprising a conduit-inlet 25; the conduit-inlet comprising a bifurcation defining a first sub inlet 72 and second sub inlet 74; a fluid displacement device 20 comprising a fluid-blowing portion mountable to the second sub-inlet 74; wherein when the fluid-blowing portion is mounted to the second sub-inlet 74 receiving end and blows air therein a vacuum is created within the first sub-inlet 72 providing the connector 25 to displace fluid and any elements within said fluid into said bag 10.

In use, bag 10 provides the general advantage that incorporating a bag-carrying arrangement 65 that closes substantially bag mouth while providing internal access only through a narrow opening 50 maximizes bag capacity. This advantage applies for all sizes of plastic and paper bag 10 of the invention. It is known that in traditional bags that have a wide open mouth, the need to provide space on bag top to be able to tie a rope or twist a metal tie is a waste of space that affects negatively the holding capacity of bag 10.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention as defined in the appended claims.

1. A bag for a fluid displacement device, said bag comprising a bag-carrying assembly, a bag-carrying arrangement and an opening adjacent to said bag-carrying arrangement for receiving a fluid-displacement portion of the fluid displacement device for entraining fluid and any elements within said fluid therein, said bag-carrying arrangement comprising an inlet configured to receive a support member therein.

2. A bag according to claim 1, wherein said bag-carrying assembly is provided at a top portion thereof.

3. A bag according to claim 1, wherein said fluid-displacement portion comprises a discharge portion.

4. A bag according to claim 1, wherein said bag comprises air vents.

5. A bag according to claim 4, wherein said air vents comprise perforations.

6. A bag according to claim 1, wherein said bag-carrying assembly comprises a bag-carrying member.

7. A bag according to claim 6, wherein said bag-carrying member comprises a strap member.

8. A bag according to claim 1, wherein said support member is configured to receive a strap member.

9. A bag according to claim 1, wherein said support member comprises an elongate member selected from the group consisting of a hollow structure, a solid structure, a casing, and a collar.

10. A bag according to claim 1, wherein said inlet is defined between two adjacent seams.

11. A bag according to claim 10, wherein said two adjacent seams comprise upper and lower seams, said lower seam comprising a downward portion providing for said opening to comprise a downward arrangement.

12. A bag according to claim 9, wherein said two adjacent seams comprise upper and lower seams, said lower seam comprising an upward oblique portion providing for said opening to comprise an upwardly slanted arrangement.

13. A bag according to claim 6, wherein said bag carrying member is mountable to said support member.

14. A bag according to claim 12, wherein said bag-carrying member comprises a shoulder strap, said support member comprising an elongate member.

15. A bag according to claim 14, wherein said shoulder strap is mounted on said elongate member.

16. A bag according to claim 15, wherein said strap comprises a hook member, said elongate member comprising a corresponding aperture.

17. A bag according to claim 15, wherein said strap member comprises a clip member for being clipped on said elongate member.

18. A bag according to claim 14, wherein said inlet includes an opening for exposing a portion of said elongate member in said inlet, said strap member being mountable to said exposed portion of said elongate member.

19. A bag according to claim 14, wherein said strap member includes a hook member, said exposed portion of said elongate member including an aperture for receiving said hook member.

20. A bag according to claim 1, wherein said support member comprises securing-member for securing said bag to said discharge portion and about said opening.

21. A bag according to claim 20, wherein said securing-member is selected from the group consisting of an adjustable band forming a loop, a fastener, a strap, a string, an alligator-type clamp, a wide jaw clamp, a clip, a ring, a lock, a fixed size collar, an adjustable size collar and combinations thereof.

22. A bag according to claim 19, wherein said support member comprises a member selected from the group of a hollow elongate member having a band; a clamp member having cooperating jaws.

23. A bag according to claim 22, wherein said elongate member includes an aperture at one longitudinal end thereof, said band being mounted at one end to said elongate member near said aperture and at an opposite end within said elongate member, said band passing through said aperture so as to form a loop.

24. A bag according to claim 22, wherein said elongate member includes two side apertures at one longitudinal end thereof, said band one end forming a loop outwardly of said elongate member, said band opposite end passing through said elongate member and being adjustable by a biasing member mounted within the elongate member.

25. A bag according to claim 24, wherein said band is mounted at its said opposite end to a biasing member mounted within said elongate member, said biasing member outwardly biasing said band from said elongate member.

26. A bag according to claim 25, wherein said band is provided with a stopper, said elongate member comprising a shoulder, said stopper being adapted to abut said shoulder so as to position said band against said biasing member.

27. A bag according to claim 26, wherein said stopper comprises a protrusion, said shoulder being formed by side opening in said elongate member.

28. A bag according to claim 26, wherein said biasing member comprises a tension spring.

29. A bag according to claim 1, wherein said bag opening is configured to receive a discharge connector.

30. A bag according to claim 29, wherein said discharge connector is selected from the group consisting of a rectangular discharge connector, a circular discharge connector, an oval discharge connector and a flexible discharge connector.

31. A bag according to claim 1, wherein said support member comprises a hanger-type handle.

32. A bag according to claim 1, wherein said opening having a removable portion providing said bag with a size selectable opening at an upper portion thereof.

33. A bag according to claim 32, wherein said removable portion comprises a tearable section.

34. A bag according to claim 22, wherein one end of said elongate member comprising two side-apertures at one longitudinal end, said band one end forming a loop outwardly adjustable of said elongate member, said loop passing through said two side-apertures, said band opposite end passing within said elongate member, the band having lockable teeth and being outwardly adjustable.

35. A bag according to claim 1, wherein said fluid being displaced by said fluid displacement device is selected from the group consisting of air, gas, liquids and a combination thereof.

36. A bag according to claim 1, wherein said fluid displacement device comprises a device selected from the group consisting of a blower/vacuum, a blower, a lawn mower, a shredder, a ventilator, a gas exhaust pipe, a gas released from a compressed vessel, a pneumatic gun, a pneumatic suction gun, a fluidic suction equipment, a power vacuum, a manually-operated vacuum, and a combination thereof.

37-50. (canceled)

51. A bag-carrying assembly for a bag for a fluid displacement device, said bag comprising bag-carrying-member-receiving elements, and an opening for receiving a discharge portion of the fluid displacement device, said assembly comprising:
a support member comprising a longitudinal member for being mounted to said bag-carrying-member receiving elements; and
a securing-member mounted to said longitudinal member for securing the bag to the discharge portion about the opening.

52-68. (canceled)

69. A fluid displacement assembly comprising:
a fluid displacement device comprising a fluid discharge portion;
a bag comprising a bag-carrying assembly comprising a bag-carrying arrangement adjacent to an opening for receiving said fluid-discharge portion of said fluid displacement device;
whereby when said fluid-discharge portion is in fluid communication with said opening, fluid and any elements within said fluid may flow in and filtered fluid may exit said bag, said bag-carrying arrangement comprises an inlet configured to receive a support member therein.

70-79. (canceled)

80. A fluid displacement assembly comprising:
a bag comprising an opening;
a conduit mountable to said bag opening and comprising a conduit-inlet;
a fluid displacement device comprising a fluid-blowing portion mountable to said conduit-inlet;
wherein said fluid-blowing portion is so mountable to said conduit-inlet as to create a vacuum within said conduit to displace fluid and any elements within said fluid therethrough into said bag.

81. A bag according to claim 9, wherein said hollow structure comprises a conduit.

82. A bag according to claim 81, wherein said conduit comprises a hose.
